(19) United States
(12) Patent Application Publication
(10) Pub. No.: US 2003/0065931 A1
(43) Pub. Date: Apr. 3, 2003

(54) Semiconductor integrated circuit, method for testing semiconductor integrated circuit, and semiconductor storage apparatus

(75) Inventors: Katsuhiro Nakai, Sanda-shi (JP); Tsuyoshi Namba, Hirakata-shi (JP); Takehisa Hirano, Minoo-shi (JP); Tomoaki Tezuka, Higashi Yodogawa-ku (JP); Takamasa Shibauchi, Moriguchi-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/192,851

(22) Filed: Jul. 11, 2002

(30) Foreign Application Priority Data
Jul. 11, 2001 (JP) 2001-210838

(51) Int. Cl. H04L 9/32; G06F 11/30; G06F 12/14

(52) U.S. Cl. 713/193

(57) ABSTRACT

A semiconductor IC 1 is provided with an address input terminal 3 to which addresses for reading secret data stored in the semiconductor IC are supplied from the outside; an input terminal 7 to which a switching control signal C1 for selecting the addresses inputted to the address input terminal 3 is supplied; an arithmetic circuit 6 for performing an arithmetic operation according to a predetermined secret rule on secret data D1˜Dm which are read out; and a test output terminal 8 for outputting results E1˜Ek of the arithmetic circuit 6 to the outside of the semiconductor IC 1. Therefore, the secret data D1˜Dm can easily be read to the outside when the semiconductor IC 1 is subjected to a test or the like, while maintaining confidentiality of the secret data.

### FIELD OF THE INVENTION

The present invention relates to a semiconductor integrated circuit (hereinafter referred to as a semiconductor IC) in which effective data are stored, a method for testing the semiconductor IC, and a semiconductor storage apparatus.

### BACKGROUND OF THE INVENTION

Heretofore, a semiconductor IC has performed its duty as a component of various devices or systems. However, with an advance in semiconductor technology in recent years, it has become possible to implement a function that has conventionally been constituted by plural components, with a single semiconductor IC, and therefore, a semiconductor IC becomes to have a function as, not only a component of a device or system, but also a system itself.

Meanwhile, as the Internet has become widespread, a network employing personal computers as mediums is growing as a big infrastructure of communication next to a conventional network using telephones or the like. In the network system employing personal computers such as the Internet, self-defense is required of each individual user to secure the safety of the network, in contrast with the conventional network system using telephones or the like, wherein it is evident who secures the safety. Accordingly, in services of the Internet, typified by electronic commerce, there is a need for a system using encryption and authentication techniques to prevent illegal acts by third parties, such as falsification of data or tapping.

As described above, on the network using the Internet, as the opportunity of using secret data that should not be disclosed to third parties, such as keys for encryption/authentication as information required for the network system to function or individual information, has been increased, these secret data are increasingly stored in semiconductor ICs. In such network, it is desired that only authorized persons, such as owners of the information or systems, can operate the systems using the secret data stored in the semiconductor ICs or read the secret data, and therefore, it is important to securely protect the secret data so as not to leak the data to the third parties.

As described above, it is necessary to securely protect the secret data so as not to leak the data to the third parties. On the other hand, in a shipping flow of semiconductor ICs containing secret data, it is necessary to easily read the secret data from the ICs. Accordingly, the semiconductor ICs are provided with test circuits or the like so that the secret data can be directly read by the test circuits or the like.

For example, in a conventional test circuit for a semiconductor IC shown in FIG. 18, output data 43 (secret data) from an arbitrary part of an information processing unit 34 is directly outputted to an external terminal 63, and its status is observed by an external test terminal 33. A ROM dump system belongs to this category of test circuits. The conventional test circuit has the advantages that it is relatively simple in function, and excellent in observability. However, the high observability leads to the disadvantage that the processing result of the information processing unit 34 is easily utilized by third parties.

Accordingly, even when the secret data stored in the semiconductor IC is securely protected, if the specification of the test circuit is once leaked to a third party, the processing result is easily utilized by the third party, and therefore, the protection itself for the secret data stored in the semiconductor IC does not make any sense.

As a solution of the above-mentioned problem, a test circuit for further enhancing the confidentiality of LSI is disclosed in Japanese Published Patent Application No. Hei. 6-124241.

Hereinafter, this test circuit will be described with reference to FIG. 19. FIG. 19 is a block diagram illustrating the construction of the test circuit.

With reference to FIG. 19, a semiconductor IC 71 is provided with a control circuit 72, an address generator 73, an EEPROM (Electric Erasable Programmable Read Only Memory) 75, a ROM (Read Only Memory) 76, and a scramble circuit 77, and an EEPROM 78 is connected to the semiconductor IC 71 through an output terminal 88.

The semiconductor IC 71 constructed as described above performs control and arithmetic operations through the control circuit 72, according to various kinds of commands, data, and the like which are included in the internal ROM 76, thereby controlling the operation of the whole semiconductor IC 71.

Furthermore, the semiconductor IC 71 is provided with a test terminal 74, a control signal input terminal 86, and a data/address input terminal 87, and the control circuit 72 contains a test circuit body 90. The scramble circuit 77 receives an output signal 83 from the internal EEPROM 75, an output signal 82 from the ROM 76, and an output signal 89 from the external EEPROM (ROM) 78, and processes these signals to output an output signal 81 to various control circuits, and an external output signal 80.

Generally, the production side of the semiconductor IC 71 and the user side of the semiconductor IC 71 have common data, and judgements such as authorization are carried out on the basis of the common data. That is, turning to FIG. 19, when the contents of the EEPROM 75 that is provided in the semiconductor IC 71 are identical to the contents of the external EEPROM 78, judgements such as authorization are carried out correctly. The contents (secret data) of the ROM 76 are scrambled in the scramble circuit 77 according to the internal EEPROM 75, and restored to the normal data after passing through the scramble circuit 77. Accordingly, if the scrambling is not correctly carried out, the control signals are not correctly supplied to the respective control circuits. On the other hand, during the test mode, the contents of the ROM 76 are scrambled according to the external EEPROM 78, and outputted through an external terminal (not shown) to be observed. Accordingly, the command codes or the like cannot be correctly observed unless the data are correctly inputted to the external EEPROM 78 and the scrambling is correctly carried out.

Hereinafter, the operation of the conventional semiconductor IC 71 constructed as described above will be described.

The control circuit 72 controls the operation and arithmetic of the semiconductor IC 71, and the control circuit 72 is controlled by plural control signals supplied from the control signal input terminal 86. Simultaneously, the addresses, data, and the like, which are supplied from the outside through the data/address signal input terminal 87, are used for data writing into the internal EEPROM 75 as well as for control and arithmetic operation in the control circuit 72. The address generator 73, which is a kind of a control circuit, outputs an address signal 84 to the external EEPROM 78 through the internal EEPROM 75, the ROM 76, and the output terminal 88. The output signal 82 from the ROM 76 and the output signal 83 from the internal EEPROM 75 are inputted to the scramble circuit 77, and it is determined whether the scramble circuit 77 should be controlled by the output signal 83 from the internal EEPROM 75 or the output signal 89 from the internal EEPROM 78, according to a control signal 79 from the control circuit 72.

During the test mode, it is determined by the control signal 79 that the scramble circuit 77 should be controlled according to the output 89 from the external EEPROM 78, whereby the contents of the ROM 76 are scrambled according to the external EEPROM 78, and the scrambled output 80 is observed through the external terminal (not shown).

That is, in the conventional technique described above, the scramble circuit 77 is provided inside the semiconductor IC 71 and the EEPROM 78 which outputs the command of scrambling is provided outside the semiconductor IC 71, thereby to prevent the secret data stored in the ROM 76 from being easily read from the outside of the semiconductor IC 71.

However, in the above-mentioned construction where the EEPROM 78 having the same contents as those stored in the internal EEPROM 75 is provided outside the semiconductor IC 71, if the contents of the external EEPROM 78 are once leaked out, the secret data stored in the IC 71 are undesirably leaked out not only when the IC 71 is tested but also when it is normally used.

Further, providing the EEPROM 78 outside the semiconductor IC 71 for performing tests thereof leads to disadvantages in production cost and facility of tests.

### SUMMARY OF THE INVENTION

The present invention is made to solve the above-described problems and has for its object to provide a semiconductor IC that is easily tested while maintaining high confidentiality, a method for testing the semiconductor IC, and a semiconductor storage apparatus that is difficult to decrypt and has very high confidentiality.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and an arithmetic unit for performing an arithmetic operation according to a predetermined secret rule, on the secret data which are read from the storage unit according to the second address signal, and outputting a result of the arithmetic operation to the outside. Therefore, only a person who knows the secret rule for the secret data which should not be disclosed to third parties, can recognize the meaning of the result outputted from the arithmetic unit, whereby a condition for reading the secret data is newly added. Accordingly, a test on the semiconductor IC can be easily carried out while maintaining high confidentiality with a relatively simple circuit construction.

According to a second aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and an arithmetic unit for arithmetically operating plural data which are supplied from the outside, and determining, according to combinations of the data, whether the secret data which are read from the storage unit according to the second address signal are to be outputted to the outside or not. Therefore, the secret data can be outputted to the outside only when the externally inputted data according to a specific rule are in correct combinations, whereby the procedure for directly outputting the secret data to the outside is kept secret, and only a person who knows the procedure can easily read the secret data. Accordingly, a test on the semiconductor IC can be easily carried out while maintaining high confidentiality.

According to a third aspect of the present invention, a semiconductor IC includes: a storage unit for holding secret data; an arithmetic unit for arithmetically operating plural data which are supplied from the outside, and outputting, according to combinations of the data, a selection signal for selecting an address signal to be given to the storage unit; and an address signal selection unit for selecting either a first address signal to be given to the storage unit when the semiconductor IC is normally used, or a second address signal to be given to the storage unit when the semiconductor IC is tested, according to the selection signal supplied from the arithmetic unit, and outputting the selected signal to the storage unit. Therefore, the address signal for reading the secret data can be generated only when the externally inputted data according to a specific rule are in correct combinations, whereby the procedure for directly outputting the secret data to the outside is kept secret, and only a person who knows the procedure can easily read the secret data. Accordingly, a test on the semiconductor IC can be easily carried out while maintaining high confidentiality.

According to a fourth aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and a timing detection unit for outputting the selection signal so as to enable the second address signal only during a predetermined period of time, thereby controlling the address signal selection unit. Therefore, the address signal for reading the secret data can be enabled only during the predetermined period of time, and only a person who knows this period can directly read the secret data from the outside. Accordingly, a test on the semiconductor IC can be easily carried out while maintaining high confidentiality.

According to a fifth aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and plural fuses which are able to disconnect conducting paths by applying a predetermined voltage or current to the fuses; wherein said fuses are placed in a path through which the second address signal supplied from the outside is inputted to the address signal selection unit, and in a path through which the secret data read from the storage unit are outputted to the outside. Therefore, when the semiconductor IC is tested, the secret data can be easily read out. On the other hand, after the test, the fuses are disconnected to set the semiconductor IC in such a state that the secret data cannot be read from the outside. Accordingly, the test on the semiconductor IC is facilitated without degrading the confidentiality of the secret data.

According to a sixth aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; an address input terminal to which the second address signal is supplied from the outside; and an output terminal for outputting the secret data which are read from the storage unit according to the second address signal, to the outside; wherein, among plural terminals on a wafer, said address input terminal and said output terminal are not connected to external terminals of a package of the semiconductor IC. Since the external terminals for the address signal for reading the secret data, the control signal input, and the secret data output, which are used for testing the semiconductor IC, are not connected to the package, readout of the secret data becomes significantly difficult after the test, although the secret data can be easily read during the test. Accordingly, the test on the semiconductor IC is facilitated and, after the test, the secret data are prevented from being leaked to third parties.

According to a seventh aspect of the present invention, a semiconductor IC includes: a storage unit for holding secret data; an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; an address input terminal to which the second address signal is supplied from the outside; and an output terminal for outputting the secret data which are read from the storage unit according to the second address signal, to the outside of the semiconductor IC; wherein said address input terminal and said output terminal are not protected against electrostatic destruction. Therefore, the secret data can be easily read during the test on the semiconductor IC and, after the test, the external terminals are destroyed, and readout of the secret data becomes significantly difficult, thereby preventing the secret data from being leaked to third parties.

According to an eighth aspect of the present invention, a semiconductor IC includes: first and second storage units each holding secret data, and being unreadable from the outside; and a comparison unit for comparing the data stored in the first storage unit and the data stored in the second storage unit to judge whether these data are identical or not, and outputting a result of the comparison to the outside. Therefore, a check of the correctness of the data stored in the storage units wherein the secret data that should not be disclosed to third parties, can be carried out inside the storage units, without direct control or observation from the outside of the semiconductor IC. Accordingly, the test on the semiconductor IC can be carried out while maintaining the confidentiality of the secret data.

According to a ninth aspect of the present invention, in the semiconductor IC according to the eighth aspect, the first and second storage units hold the same secret data. Therefore, the same effects as described for the eighth aspect can be achieved.

According to a tenth aspect of the present invention, a method for testing the semiconductor IC according to the eighth or ninth aspect comprises: a reading step of reading the data stored in the first and second storage units; a comparison step of comparing the data read from the first storage unit and the data read from the second storage unit to judge whether these data are identical or not; and an output step of outputting a result of the comparison in the comparison step to the outside. Therefore, the same effects as described for the eighth aspect can be achieved.

According to an eleventh aspect of the present invention, a test program for allowing a computer to execute a test on the semiconductor IC according to the eighth or ninth aspect comprises: a reading step of reading the data stored in the first and second storage units; a comparison step of comparing the data read from the first storage unit and the data read from the second storage unit to judge whether these data are identical or not; and an output step of outputting a result of the comparison in the comparison step to the outside. Therefore, the same effects as described for the eighth aspect can be achieved.

According to a twelfth aspect of the present invention, a semiconductor IC includes: first and second storage units each holding secret data, and being unreadable from the outside; and a comparison unit for comparing the data stored in the first storage unit and the data stored in the second storage unit to judge whether these data are different from each other or not, and outputting a result of the comparison to the outside. Therefore, the same effects as described for the eighth aspect can be achieved.

According to a thirteenth aspect of the present invention, in the semiconductor IC according to the twelfth aspect, the first and second storage units hold mutually-inverted secret data. Therefore, the same effects as described for the eighth aspect can be achieved.

According to a fourteenth aspect of the present invention, a method for testing the semiconductor IC according to the twelfth or thirteenth aspect, comprises: a reading step of reading the data stored in the first and second storage units; a comparison step of comparing the data read from the first storage unit and the data read from the second storage unit to judge whether these data are different from each other or not; and an output step of outputting a result of the comparison in the comparison step to the outside. Therefore, the same effects as described for the eighth aspect can be achieved.

According to a fifteenth aspect of the present invention, a test program for allowing a computer to execute a test on the semiconductor IC according to the twelfth or thirteenth aspect, comprises: a reading step of reading the data stored in the first and second storage units; a comparison step of comparing the data read from the first storage unit and the data read from the second storage unit to judge whether these data are different from each other or not; and an output step of outputting a result of the comparison in the comparison step to the outside.

According to a sixteenth aspect of the present invention, the semiconductor IC according to any of the eighth, ninth, twelfth, and thirteenth aspects, further includes first and second arithmetic units for performing arithmetic operations to check the correctness of the secret data stored in the first and second storage units, respectively, and outputting results of the arithmetic operations to the outside. Therefore, defectives can be checked at a higher probability, and the confidentiality of the secret data can be protected without directly controlling or observing the storage units where the secret data that should not be disclosed to third parties are stored. Further, even when one of the two storage units is a defective, the other storage unit can be selected. As a result, the yield in the test on the semiconductor IC is improved.

According to a seventeenth aspect of the present invention, a method for testing the semiconductor IC according to the tenth or fourteenth aspect comprises: an arithmetic step of performing arithmetic operations to check the correctness of the secret data stored in the first and second storage units; and an output step of outputting a result obtained in the arithmetic step to the outside. Therefore, the same effects as mentioned for the sixteenth aspect can be achieved.

According to an eighteenth aspect of the present invention, the semiconductor IC test program according to the eleventh or fifteenth aspect further includes: an arithmetic step of performing arithmetic operations to check the correctness of the secret data stored in the first and second storage units; and an output step of outputting a result obtained in the arithmetic step to the outside. Therefore, the same effects as mentioned for the sixteenth aspect can be achieved.

According to a nineteenth aspect of the present invention, a semiconductor IC includes: first and second storage units each holding secret data; first and second arithmetic units for performing arithmetic operations to check the correctness of the secret data stored in the first and second storage units, respectively; a self-judgement unit for making a judgement to select either the first storage unit or the second storage unit, on the basis of the results of the arithmetic operations performed by the first and second arithmetic units; and a selection unit for selecting a storage unit to be used from between the first and second storage units, on the basis of the result of the judgement of the self-judgement unit. Therefore, the semiconductor IC can be tested without directly controlling or observing the storage units where the secret data that should not be disclosed to third parties, from the outside. Further, even when one of the two storage units is a defective, the other storage unit can he used as a result, the yield in the test on the semiconductor IC is improved.

According to a twentieth aspect of the present invention, a semiconductor IC includes: a storage unit for holding secret data; and an information processing unit for holding, as internal data, the same data as the secret data stored in the storage unit; wherein the information processing unit compares the internal data with the secret data stored in the storage unit, and outputs a result of the comparison to the outside. Therefore, the semiconductor IC can be tested without directly controlling or observing the storage units where the secret data that should not be disclosed to third parties, from the outside, while maintaining the confidentiality of the secret data. Further, even when one of the two storage units is a defective, the other storage unit can be used. As a result, the yield in the test on the semiconductor IC is improved.

According to a twenty-first aspect of the present invention, in the semiconductor IC according to the twentieth aspect, the information processing unit holds the same data as the secret data stored in the storage unit, in a part of software that is contained in the information processing unit. Therefore, the same effects as mentioned for the twentieth aspect are achieved. Further, since the information processing unit holds the internal data as a part of software, the execution speed of the test can be increased.

According to a twenty-second aspect of the present invention, a semiconductor storage apparatus includes a storage unit having a capacity larger than an amount of effective data; wherein the effective data are placed in a first data storage area that is a part of a data storage area of the storage unit, and ineffective data are placed in a second data storage area other than the first data storage area. Therefore, it is extremely difficult to analyze where the effective data are placed in the storage unit, whereby the confidentiality of secret data, which are the effective data stored in the storage unit, is significantly improved.

According to a twenty-third aspect of the present invention, a semiconductor storage apparatus includes plural storage units for holding data; wherein effective data are stored in at least one of the plural storage units, and ineffective data are stored in the remaining storage units other than the storage unit which hold the effective data. Therefore, it is extremely difficult to analyze where the effective data are placed among the plural storage units, whereby the confidentiality of secret data, which are the effective data stored in the storage units, is significantly improved.

According to a twenty-fourth aspect of the present invention, in the semiconductor storage apparatus according to the twenty-third aspect, the plural storage units are arranged such that the storage unit holding the effective data is surrounded by the storage units holding the ineffective data. Therefore, in addition to the above-mentioned effects, the result of the test on the ineffective data can be used for the test on the effective data. As a result, even a person who conducts the test cannot obtain the secret data which are the effective data stored in the storage units.

According to a twenty-fifth aspect of the present invention, in the semiconductor storage apparatus according to the twenty-second aspect, the effective data and the ineffective data are alternately arranged in the data storage area of the storage unit. Therefore, the same effects as mentioned for the twenty-fourth aspect can be achieved.

According to a twenty-sixth aspect of the present invention, in the semiconductor storage apparatus according to any of the twenty-second to twenty-fifth aspects, the part of the storage unit holding the ineffective data is readable from the outside, and the part of the storage unit holding the effective data is unreadable from the outside. Therefore, secret data, i.e., the effective data, are never read to the outside, whereby the confidentiality of the secret data is further improved. On the other hand, a test on the ineffective data is facilitated, and the result of the test on the ineffective data storage read can be used for detecting a defect in the effective data storage area, Whereby the semiconductor storage apparatus can be tested without reading the effective data to the outside.

According to a twenty-seventh aspect of the present invention, in the semiconductor storage apparatus according to any of the twenty-second to twenty-sixth aspects, the storage unit consists of at least one EP-ROM; and the EP-ROM is sealed in a package that is opaque to ultraviolet rays. Therefore, when a third party tries to open the storage unit itself, secret data stored in the storage unit are destroyed by ultraviolet rays included in light from lighting equipment or the like, resulting in a semiconductor storage apparatus having significantly high confidentiality of secret data.

### BRIEF DESCRIPTION OF THE DRAWINGS

FIG. 1 is a block diagram illustrating a semiconductor IC according to a first embodiment of the present invention.

FIG. 2 is a block diagram illustrating a semiconductor IC according to a second embodiment of the present invention.

FIG. 3 is a block diagram illustrating a semiconductor IC according to a third embodiment of the present invention.

FIG. 4 is a block diagram illustrating a semiconductor IC according to a fourth embodiment of the present invention.

FIG. 5 is a block diagram illustrating another semiconductor IC according to the fourth embodiment of the present invention.

FIG. 6 is a block diagram illustrating a semiconductor IC according to a fifth embodiment of the present invention.

FIG. 7 is a block diagram illustrating a semiconductor IC according to sixth and seventh embodiments of the present invention.

FIG. 8 is a block diagram illustrating a semiconductor IC according to eighth and ninth embodiments of the present invention.

FIG. 9 is a block diagram illustrating a semiconductor IC according to a tenth embodiment of the present invention.

FIG. 10 is a block diagram illustrating a semiconductor IC according to an eleventh embodiment of the present invention.

FIG. 11 is a block diagram illustrating a semiconductor IC according to a twelfth embodiment of the present invention.

FIG. 12 is a block diagram illustrating a semiconductor IC according to a thirteenth embodiment of the present invention.

FIG. 13 is a conceptual diagram of a memory map illustrating an arrangement of data in a storage unit in a conventional semiconductor IC.

FIG. 14 is a conceptual diagram of a memory map illustrating an arrangement of data in a storage unit in the semiconductor IC according to the fourteenth embodiment.

FIG. 15 is a conceptual diagram of a memory map illustrating an arrangement of data in a storage unit in the semiconductor IC according to the fifteenth embodiment.

FIG. 16 is a conceptual diagram of a memory map illustrating an arrangement of data in a storage unit in the semiconductor IC according to the sixteenth embodiment.

FIG. 17 is a conceptual diagram of a memory map illustrating an arrangement of data in a storage unit in the semiconductor IC according to the seventeenth embodiment.

FIG. 18 is a block diagram illustrating a conventional test circuit for a semiconductor IC.

FIG. 19 is a block diagram illustrating a conventional test circuit for a semiconductor IC.

### DETAILED DESCRIPTION OF THE PREFERRED EMBODIMENT

[Embodiment 1]

Hereinafter, a first embodiment of the present invention corresponding to claim 1 will be described.

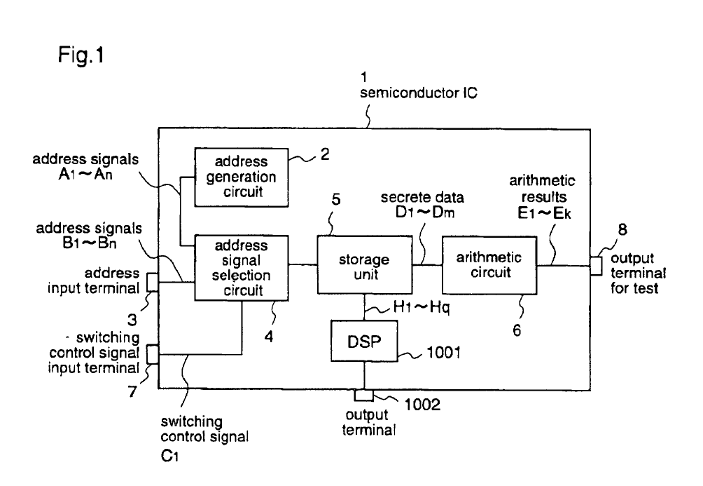

FIG. 1 is a block diagram illustrating a semiconductor IC according to the first embodiment of the present invention.

In FIG. 11 a semiconductor IC 1 comprises an address generation circuit 2 for generating address signals (first addresses signals) A1˜An to be used when the semiconductor IC 1 is normally used; an address input terminal 3 for receiving address signals (second address signals) B1˜Bn supplied from the outside, which addresses are to be used when the semiconductor IC 1 is tested; an address signal selection circuit (address signal selector) 4 for selecting either the address signals A1˜An or the address signals B1˜Bn according to a switching control signal (selection signal) C1; a switching control signal input terminal 7 which receives the switching control signal C1 for controlling the selection of the address signals A1˜An or B1˜Bn by the address signal selection circuit 4; a storage unit 5 for holding secret data to be concealed from the third party, and reading arbitrary secret data stored, according to the address signal outputted from the address signal selection circuit 4; an arithmetic circuit (arithmetic unit) 6 for performing arithmetic processing on the selected secret data D1˜Dm, according to a predetermined secret rule; an output terminal 8 for test (hereinafter referred to as a test output terminal) which outputs arithmetic results E1˜Ek obtained in the arithmetic circuit 6 to the outside of the semiconductor IC 1; a DSP (Digital Signal Processor) 1001 for performing processing, such as decoding of the secret data, using key information that is stored in the storage unit 5 together with the secret data; and an output terminal 1002 for outputting a processing result of the DSP 1001 to the outside of the semiconductor IC 1.

Next, the operation of the semiconductor IC 1 so constructed will be described.

Initially, when the semiconductor IC 1 is normally used, the address signal selection circuit 4 automatically selects the address signals A1˜An which are generated from the address generation circuit 2 included in the semiconductor IC 1. When the address signals A1˜An are supplied from the address signal selection circuit 4 to the storage unit 5, the storage unit 5 outputs the stored secret data H1˜Hq according to the address signals A1˜An. For example, the secret data H1˜Hq are music data which are encrypted using key information and stored in a data storage region. Then, the DSP 1001 such as a microcomputer (information processor) converts the secret data into data of a desired format by subjecting the secret data to a process such as decoding using the key information, and thereafter, outputs the secret data from the output terminal 1002 to the outside of the semiconductor IC 1. During the normal operation, it is impossible to read the secret data H1˜Hq themselves from the terminals 3, 7, 8 other than the output terminal 1002 to the outside of the semiconductor IC 1.

Next, when the semiconductor IC 1 is tested, the switching control signal input terminal 7 is supplied with the switching control signal C1 for selecting the address signals B1˜Bn which are inputted through the address input terminal 3. On receipt of the switching control signal C1, the address signal selection circuit 4 selects the address signals B1˜Bn according to the switching control signal C1, and outputs them to the storage unit 5. On receipt of the address signals B1˜Bn, the storage unit 5 outputs the stored secret data D1˜Dm according to the address signals B1˜Bn. The secret data D1˜Dm read from the storage unit 5 are subjected to an arithmetic operation according to a predetermined secret rule that is different from the processing performed by the DSP 1001 during the normal operation, and data E1˜Ek as a result of the arithmetic operation are outputted to the test output terminal 8. Then, the data E1˜Ek outputted from the test output terminal 8 are observed by a tester (not shown) provided outside the semiconductor IC 1 to judge whether the data E1˜Ek are predetermined correct data or not, thereby judging whether the semiconductor IC 1 is correctly manufactured or not. Since the data E1˜Ek outputted from the test output terminal 8 have been operated according to the secret rule in the arithmetic circuit 6, even when a third party illegally reads the secret data from the semiconductor IC 1 using a test circuit, the third party cannot decode the secret data unless he/she knows the arithmetic rule of the arithmetic circuit. For example, it is assumed that the secret data stored in the storage unit 5 are encrypted music data and key data for decrypting the data, and the secret rule of the arithmetic operation by the arithmetic operation 6 is a rule for inverting the data. In this case, the data outputted from the test output terminal 8 are inverse data of the data stored in the storage unit 5. However, unless the third party previously knows the secret rule (to output the inverse data) of the arithmetic operation 6, the data outputted from the test output terminal 8 are merely data of “0” and “1” having no meaning, for the third party.

As described above, the semiconductor IC 1 according to the first embodiment is provided with the address signal selection circuit 4 which selects either the address signals A1˜An that are generated by the address generation circuit 2 to be used when the IC 1 is normally used, or the address signals B1˜B2 that are supplied from the outside to be used when the IC 1 is tested, according to the switching control signal C1, and the arithmetic circuit 6 which subject the secret data outputted from the storage unit 5 to an arithmetic operation according to a predetermined secret rule, only when the switching control signal C1 is inputted so that the address signals B1˜Bn are given to the storage unit 5. Therefore, even when a third party tries to read the secret data illegally using a test circuit, the data read to the outside of the semiconductor IC 1 are the arithmetic results E1˜Ek that have been obtained by the arithmetic operation according to the secret rule in the arithmetic circuit 6, whereby the secret data, which should not be disclosed to the third party and are stored in the storage unit 5 of the semiconductor IC 1, can be securely protected. Further, when a circuit test is performed on the semiconductor IC 1, the secret data can be easily and safely read to the outside of the semiconductor IC 1, whereby the circuit test is facilitated.

While in this first embodiment the DSP 1001 performs decoding, the DSP 1001 may perform processing other than decoding, such as encoding, on the secret data.

Further, while in this first embodiment the storage unit 5 holds the secret data and the key information, the storage unit 5 may hold only the key information while the secret data is stored. in another storage unit.

Furthermore, while in this first embodiment the secret data stored in the storage unit 5 are copyright data such as key information for encryption or music data, the secret data may be any data, such as personal information, as long as the data requires confidentiality.

[Embodiment 2]

Hereinafter, a second embodiment of the present invention corresponding to claim 2 will be described with reference to the drawings.

In the above-mentioned first embodiment, the semiconductor IC 1 is provided with the arithmetic circuit 6 for performing an arithmetic operation according to a secret rule on the secret data D1˜Dm which are read from the storage unit S according to the address signals B1˜Bn during the circuit test, to output the arithmetic results E1˜Ek. However, a semiconductor IC 1a according to this second embodiment is provided with, instead of the arithmetic circuit 6, an arithmetic circuit 21 for determining as to whether the secret data read from the storage unit 5 are to be outputted to the outside or not, according to combinations of plural data signal which are supplied from the outside.

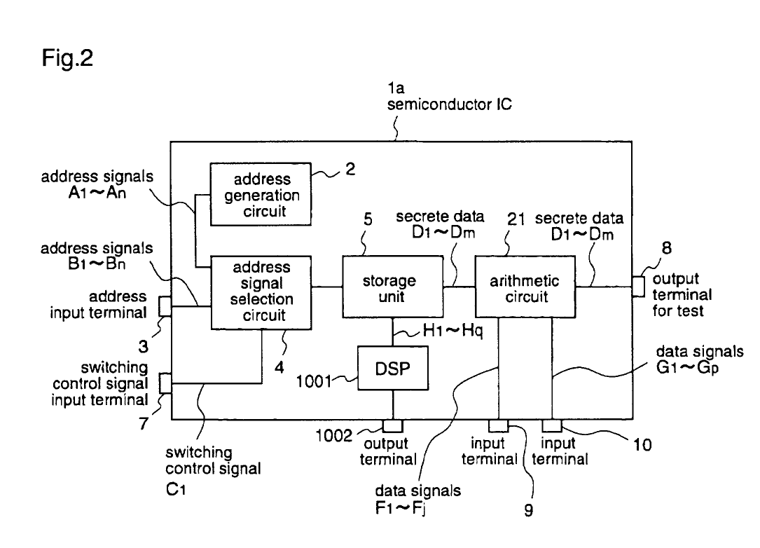

FIG. 2 is a block diagram illustrating the semiconductor IC 1a according to the second embodiment.

With reference to FIG. 2, reference numerals 9 and 10 are input terminals for inputting data signals F1˜Fj and data signals G1˜Gp to the inside of the semiconductor IC 1a, respectively. Reference numeral 21 denotes an arithmetic circuit (arithmetic unit) for operating the externally inputted data signals F1˜Fj and G1˜Gp, and determining whether the secret data which are read from the storage unit 5 according to the address signals B1˜Bn are to be outputted from the semiconductor IC 1a or not, according to the combinations of the inputted data signals.

The semiconductor IC 1a according to the second embodiment is different from the semiconductor IC 1 according to the first embodiment only in that the IC 1a is provided with the arithmetic circuit 21 instead of the arithmetic circuit 6, and the arithmetic circuit 21 determines whether the secret data are to be outputted from the semiconductor IC 1a or not, on the basis of the combinations of the data signals F1˜Fj and G1˜Gp which are supplied from the input terminals 9 and 10.

Therefore, in FIG. 2, the same constituents as those of the semiconductor IC 1 according to the first embodiment are given the same numerals, and description thereof will be omitted.

Next, the operation of the semiconductor IC 1a according to the second embodiment will be described.

Since the operation of the IC 1a when it is normally used is identical to that already described for the first embodiment, repeated description is not necessary.

Next, when the IC 1a is tested, the switching control signal C1 for selecting the address signals B1˜Bn supplied from the address input terminal 3 is supplied from the switching control signal input terminal 7. On receipt of the switching control signal C1, the address signal selection circuit 4 selects the address signals B1˜Bn. When the address signals B1˜Bn are inputted to the storage unit 5, the storage unit 5 outputs the storage secret data D1˜Dm, according to the address signals B1˜Bn. The operation up to here is identical to the operation according to the first embodiment.

Then, the plural data signals F1˜Fj and G1˜Gp are supplied from the input terminals 9 and 10 to the arithmetic circuit 21. The arithmetic circuit 21 operates the inputted data signals F1˜Fj and G1˜Gp, and outputs the secret data D1˜Dm through the test output terminal 8 to the outside only when the combinations of the inputted data signals are correct.

As described above, the semiconductor IC 1a according to the second embodiment is provided with the plural input terminals 9 and 10 through which the data signals F1˜Fj and G1˜Gp are inputted, and the arithmetic circuit 21 which checks the combinations of the input signals from the input terminals 9 and 10, and the secret data are not outputted to the outside of the IC 1a unless the correct combinations of the data signals F1˜Fj and G1˜Gp are inputted to the input terminals 9 and 10. Therefore, when the semiconductor IC 1a is normally used, the secret data, which should not be disclosed to the third party and are stored in the storage unit 5 of the semiconductor IC 1a, are securely protected. On the other hand, when a person who knows the correct combinations of the data signals F1˜Fj and G1˜Gp (i.e., a person who is authorized to refer to the secret data or to operate the semiconductor IC 1 by using the secret data) tests the IC 1a, the person can easily read the secret data to the outside to perform the test.

The semiconductor IC 1a may be further provided with the arithmetic circuit 6 according to the first embodiment to perform a secret arithmetic operation on the secret data D1˜Dm before outputting the data to the outside. In this case, the secret data is double-protected, and leakage of the secret data to the outside is avoided more effectively.

[Embodiment 3]

Hereinafter, a third embodiment of the present invention corresponding to claim 3 will be described with reference to the drawings.

While in the first embodiment of the invention the switching control signal C1 is supplied from the outside through the control signal input terminal 7, a semiconductor IC 1b according to this third embodiment is provided with an arithmetic circuit 11 for operating combinations of plural data signals supplied from the outside to generate a switching control signal C1.

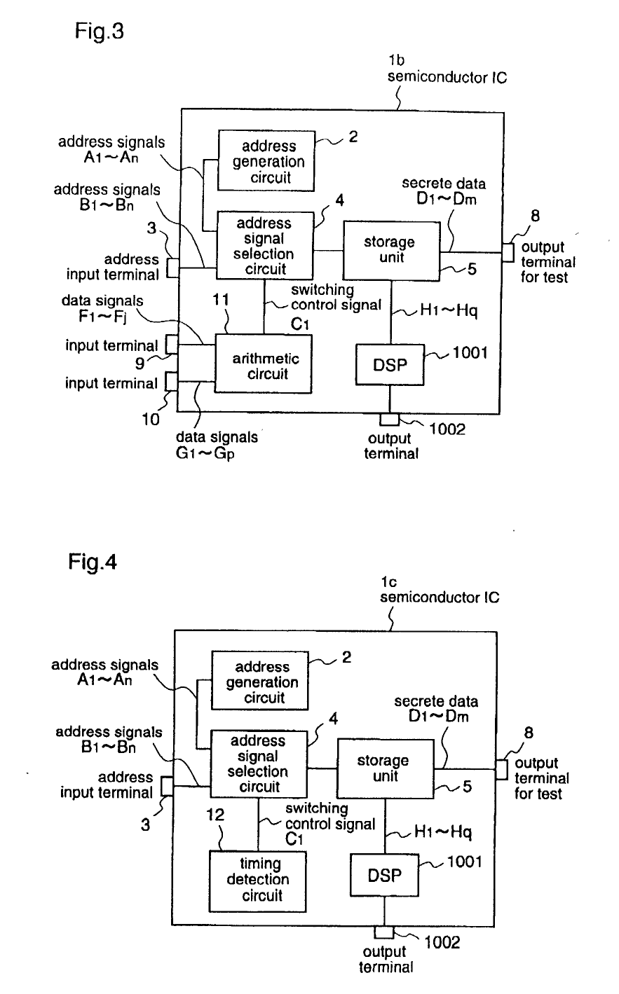

FIG. 3 is a block diagram illustrating a semiconductor IC 1b according to the third embodiment.

In FIG. 3, the semiconductor IC 1b is provided with an address generation circuit 2 for generating address signals A1˜An to be used when the semiconductor IC 1b is normally used; an address input terminal 3 as an input terminal of address signals B1˜Bn supplied from the outside, which addresses are to be used when the semiconductor IC 1 is tested; an address signal selection circuit 4 for selecting either the address signals A1˜An or the address signals B1˜Bn according to a switching control signal C1; a storage unit 5 for holding secret data to be protected from third parties, from which arbitrary secret data stored can be read according to the address signals outputted from the address signal selection circuit 4; input terminals 9 and 10 for supplying data signals (plural data) F1˜Fj and G1˜Gp to the inside of the semiconductor IC 1b, respectively; an arithmetic circuit (arithmetic unit) 11 for operating the data signals F1˜Fj and G1˜Gp to generates a switching control signal C1 according to the combinations of these data signals; and a test output terminal 8 for outputting the secret data to the outside.

Next, the operation of the semiconductor IC 1b will be described.

Initially, since the operation of the semiconductor IC 1b when it is normally used is identical to that already described for the first embodiment, repeated description is not necessary.

Next, when the semiconductor IC 1b is tested, the plural data signals F1˜Fj and G1˜Gp supplied from the input terminals 9 and 10 are inputted to the arithmetic circuit 11. The arithmetic circuit 11 operates the inputted data signals F1˜Fj and G1˜Gp. Only when the combinations of the data signals are correct, the arithmetic circuit 11 generates a switching control signal C1 that can directly read the secret data from the outside, and outputs the signal C1 to the address signal selection circuit 4.

On receipt of the switching control signal C1, the address signal selection circuit 4 selects the address signals B1˜Bn. When the address signals B1˜Bn are inputted to the storage unit 5, the storage unit 5 outputs the stored secret data D1˜Dm, according to the address signals B1˜Bn.

The secret data D1˜Dm read from the storage unit 5 are outputted to the outside through the test output terminal 8.

As described above, the semiconductor IC 1b according to the third embodiment is provided with the plural input terminals 9 and 10, and the arithmetic circuit 11 which generates the switching control signal C1 that can read the secret data directly from the outside, only when the combinations of the data signals F1˜Fj and G1˜Gp supplied from the input terminals 9 and 10 are correct, and the arithmetic circuit 11 generates no switching control signal C1 unless the data signals F1˜Fj and G1˜Gp in correct combinations are inputted to the input terminals 9 and 10. Therefore, the secret data, which should not be disclosed to third parties and are stored in the storage unit 5 of the semiconductor IC 1b, can be securely protected. On the other hand, when a person who knows the correct combinations of the data signals F1˜Fj and G1˜Gp (i.e., a person who is authorized to refer to the secret data or to operate the semiconductor IC 1b by using the secret data) tests the IC 1b, the person can easily read the secret data to perform the test.

In the semiconductor IC 1b according to the third embodiment, the arithmetic circuit 6 according to the first embodiment may be provided between the storage unit 5 and the test output terminal 8 so that the secret data D1˜Dm outputted from the storage unit 5 are transmitted through the arithmetic circuit 6 before being outputted to the outside, whereby the secret data are double-protected, and leakage of the secret data to the outside is avoided more effectively.

[Embodiment 4]

Hereinafter, a fourth embodiment of the present invention corresponding to claim 1 will be described with reference to the drawings.

While in the third embodiment the switching control signal C1 is generated by operating the combinations of the plural data signals F1˜Fj and G1˜Gp which are supplied from the outside to the arithmetic circuit 11, a semiconductor IC 1c according to this fourth embodiment is provided with a timing detection circuit 12 which generates a switching control signal C1 only during a predetermined period of time.

FIG. 4 is a block diagram illustrating the semiconductor IC 1c according to the fourth embodiment.

With reference to FIG. 4, reference numeral 12 denotes a timing detection circuit (timing detection circuit) for enabling the address signals B1˜Bn outputted from the address input terminal 3 only during a predetermined period of time, and generating a switching control signal C1 that can read the secret data directly from the outside to output the switching control signal C1 to the address signal selection circuit 4.

The semiconductor IC 1c according to this fourth embodiment is different from the semiconductor IC 1b according to the third embodiment only in that the timing detection circuit 12 is provided instead of the input terminals 9 and 10 and the arithmetic circuit 11. Therefore, in FIG. 4, the same components as those of the semiconductor IC 1b are given the same reference numerals, and description thereof will be omitted.

Hereinafter, the operation of the semiconductor IC 1c will be described.

Since the operation of the semiconductor IC during the normal operation is identical to that already described for the first embodiment, repeated description is not necessary.

When the semiconductor IC 1c is tested, assuming that the timing detection circuit 12 is a counter for counting rising edges of clocks immediately after turn-on of power and the number of counts detected by the timing detection circuit 12 is within a predetermined range, the timing detection circuit 12 generates a switching control signal C1 so that the address signal selection circuit 4 selects the address signals B1˜Bn supplied from the address input terminal 3.

To be specific, when a period during which the secret data can be read to the outside is set to a period from when the number of counts is 100 to when it is 110, the timing detection circuit 12 generates a switching control signal C1 which can read the secret data stored in the storage unit 5 directly from the outside only during the set period, and outputs it to the address signal selection circuit 4. When the address signals B1˜Bn are inputted to the storage unit 5, the storage unit 5 outputs the stored secret data D1˜Dm according to the address signals B1˜Bn.

Then, the secret data D1˜Dm read from the storage unit 5 are outputted through the test output terminal 8 to the outside.

When, in the timing detection circuit 12, the number of counts is equal to or lower than 99, or equal to or larger than 111, the timing detection circuit 12 generates a control signal C1 that cannot read the secret data directly from the outside. Accordingly, only a person who knows the period during which the timing detection circuit 12 generates the switching control signal C1 that can directly read the secret data from the outside, can read the secret data to perform a test on the IC 1c.

As described above, the semiconductor IC 1c according to the fourth embodiment is provided with the timing detection circuit 12 which generates, only during a predetermined period of time, a switching control signal C1 that can read the secret data directly from the outside, and the address signals B1˜Bn for reading the secret data selected by the switching control signal C1 are enabled during the predetermined period of time, whereby the secret data readable period is limited. Therefore, the secret data, which should not be disclosed to third parties and are stored in the storage unit 5 of the semiconductor IC 1c, can be securely protected. On the other hand, when a person who knows the predetermined period of time during which the switching control signal C1 is generated (i.e., a person who is authorized to refer to the secret data or to operate the semiconductor IC 1c by using the secret data) performs a circuit test, the person can easily read the secret data to perform the test.

In the semiconductor IC 1c according to the fourth embodiment, the arithmetic circuit 6 according to the first embodiment may be provided between the storage unit 5 and the test output terminal 8 so that the secret data D1˜Dm read from the storage unit 5 are transmitted through the arithmetic circuit 6 before being outputted to the outside, whereby the secret data is double-protected, and leakage of the secret data to the outside is avoided more effectively.

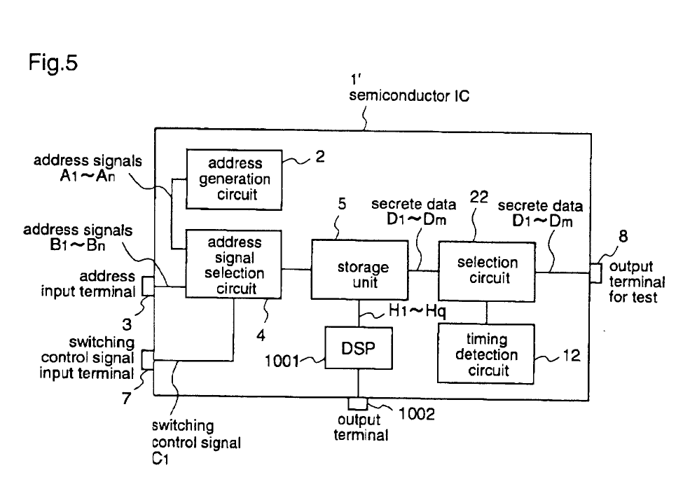

Furthermore, as shown in FIG. 5, the semiconductor IC 1 according to the first embodiment may be provided with the timing detection circuit 12 and the selection circuit 13 according to the fourth embodiment, instead of the arithmetic circuit 6 that performs an arithmetic operation according to a predetermined secret rule on the secret data outputted from the storage unit 5, and the selection circuit 22 may output the secret data D1˜Dm only during a period that is predetermined by the timing detection circuit 12. Also in this case, the same effects as described above can be achieved.

[Embodiment 5]

Hereinafter, a fifth embodiment of the present invention corresponding to claim 5 will be described with reference to the drawings.

A semiconductor IC according to this fifth embodiment is provided with fuses for cutting wires that connect the terminals used for a circuit test with the constituents of the semiconductor IC, whereby the secret data stored in the storage unit 5 are prevented from being directly read from the outside after the circuit test has ended.

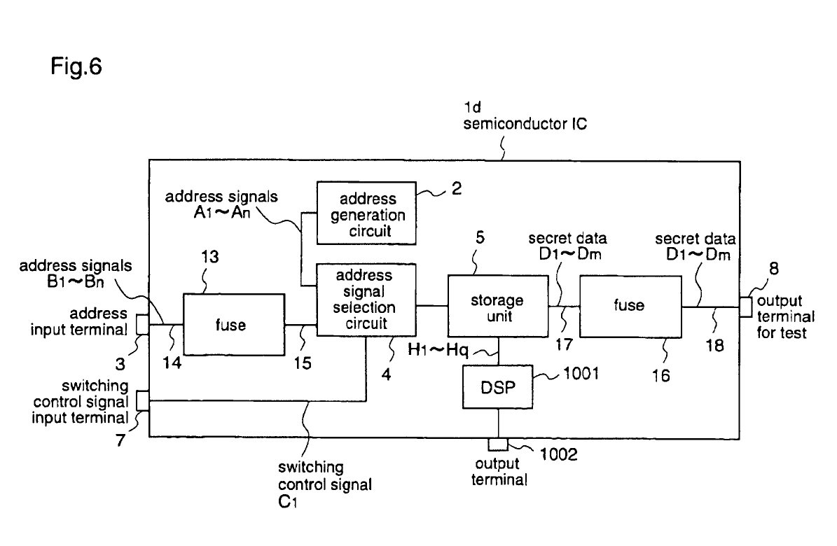

FIG. 6 is a block diagram illustrating a semiconductor IC 1d according to this fifth embodiment.

With reference to FIG. 6, the semiconductor IC 1d is provided with an address generation circuit 2 for generating address signals A1˜An to be used when the semiconductor IC 1d is normally used; an address input terminal 3 as an input terminal of address signals B1˜Bn which are supplied from the outside to be used when the semiconductor IC 1d is tested; an address signal selection circuit 4 for selecting either the address signals A1˜An or the address signals B1˜Bn according to a switching control signal C1; a control signal input terminal 7 as an input terminal of the switching control signal C1; a storage unit 5 for holding secret data that should not be disclosed to third parties, from which arbitrary secret data stored can be read according to the address signals outputted from the address signal selection circuit 4; fuses 13 and 16 each being able to disconnect a conductive path by applying a specific voltage or current; a wire 14 for transmitting the address signals B1˜Bn supplied from the address input terminal 3 to the fuse 13; a wire 15 connecting the fuse 13 with the storage unit 5; a wire 17 for transmitting the data D1˜Dm outputted from the storage unit 5 to the fuse 16; and a wire 18 connecting the fuse 16 with the output terminal 8.

Next, the operation of the semiconductor IC 1d will be described.

It is general that semiconductor IC chips are tested in a wafer, and non-defective chips that have passed the test are packaged, and then the packaged chips are tested again. In this way, several tests are carried out before shipments.

Accordingly, in this fifth embodiment, the wafer-stage test is carried out as follows. Without disconnecting the fuses 13 and 16, the address signals B1˜Bn are supplied from the address input terminal 3, through the wire 14, the fuse 13, and the wire 15, to the storage unit 5, whereby the secret data D1˜Dm are read from the storage unit 5, and then the secret data D1˜Dm are transmitted through the wire 17, the fuse 16, and the wire 18 to be outputted from the output terminal 8 to the outside. After the wafer-stage test has ended, the fuses 13 and 16 are disconnected by applying a specific voltage or current so that the secret data cannot be read to the outside using the address input terminal 3 and the test output terminal 8.

As described above, in the semiconductor IC id according to the fifth embodiment, the fuses 13 and 16 are provided between the address input terminal 3 for a circuit test and the constituents of the semiconductor IC 1d and between the test output terminal B and the constituents of the IC 1d, respectively, and the fuses 13 and 16 are disconnected by applying a specific voltage or current after the circuit test has ended, whereby the secret data are prevented from being read to the outside through the terminals 3 and 8 for the circuit test after the circuit test has ended. Therefore, confidentiality of the secret data stored in the storage unit 5 is not degraded. Further, when the semiconductor IC 1d is tested, the secret data can be easily read to the outside, whereby the circuit test is facilitated.

While in this fifth embodiment two fuses are placed between the address input terminal 3 and the address signal selection circuit 4 and between the storage unit 5 and the test output terminal 8, respectively, only one fuse may be placed between the storage unit 5 and the test output terminal 8, with the same effects as mentioned above.

[Embodiment 6]

Hereinafter, a sixth embodiment of the present invention corresponding to claim 6 will be described with reference to the drawings.

In this sixth embodiment, a semiconductor IC is tested in a wafer before it is packaged, and when it is packaged after the test, input and output terminals for the test are not connected to terminals of the package, thereby preventing the secret data stored in the storage unit 5 from being directly read from the outside.

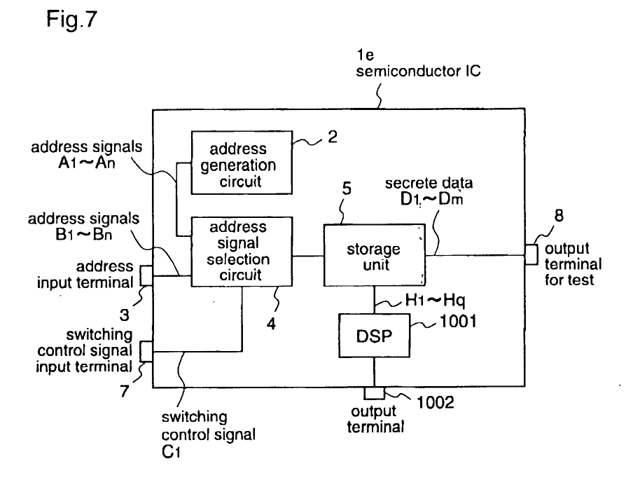

FIG. 7 is a block diagram illustrating a semiconductor IC le according to the sixth embodiment.

In FIG. 7, the semiconductor IC le is provided with an address generation circuit 2 for generating address signals A1˜An to be used when the semiconductor IC 1d is normally used; an address input terminal 3 as an on-wafer input terminal of address signals B1˜Bn which are supplied from the outside to be used when the semiconductor IC 1 is tested; an address signal selection circuit 4 for selecting either the address signals A1˜An or the address signals B1˜Bn according to a switching control signal C1; a control signal input terminal 7 as an on-wafer input terminal of the switching control signal C1; a storage unit 5 for holding secret data that should not be disclosed to third parties, from which arbitrary secret data stored can be read according to the address signals outputted from the address signal selection circuit 4; and a test output terminal 8 as an on-wafer output terminal for outputting the selected secret data D1˜Dm to the outside of the semiconductor IC 1e. The “on-wafer” means that the semiconductor IC le is not bonded when it is packaged.

Next, the operation of the semiconductor IC le will be described.

The semiconductor IC 1e is tested in a wafer. When the semiconductor IC 1e is tested, the switching control signal C1 for selecting the address signals B1˜Bn supplied from the address input terminal 3 is inputted from the switching control signal input terminal 7. On receipt of the switching control signal C1, the address signal selection circuit 4 selects the address signals B1˜Bn according to the switching control signal C1. When the address signals B1˜Bn are inputted to the storage unit 5, the storage unit 5 reads the stored secret data D1˜Dm according to the address signals B1˜Bn. Then, the secret data D1˜Dm read from the storage unit 5 are outputted to the outside through the test output terminal 8.

When the semiconductor IC 1e is packaged after the circuit test has ended, the terminals 3, 7, and 8 for the on-wafer circuit test are not electrically connected to external terminals of the package.

As described above, in the semiconductor IC le according to the sixth embodiment, the terminals 3, 7, and 8 which are provided on the wafer for a circuit test are not electrically connected (e.g., not bonded) to the package after the circuit test has ended, thereby to prevent the secret data stored in the storage unit 5 from being read to the outside through the terminals 3, 7, and 8 for the circuit test after the circuit test has ended. Therefore, after shipment of the semiconductor IC 1e, the secret data is prevented from being leaked to third parties. On the other hand, when the semiconductor IC 1e is tested, the secret data stored in the storage unit 5 can be easily read out, whereby the circuit test is facilitated, without degrading confidentiality of the secret data.

[Embodiment 7]

Hereinafter, a seventh embodiment of the present invention corresponding to claim 7 will be described with reference to the drawings.

In this seventh embodiment, terminals which are not protected from electrostatic destruction are used as input and output terminals for a circuit test on a semiconductor IC and, when the semiconductor IC is normally used after the circuit test, the input and output terminals are destroyed by the environment where the semiconductor IC is placed or by electrostatic that is built up in the terminals themselves, thereby preventing the secret data stored in the storage unit 5 from being directly read from the outside.

FIG. 7 is a block diagram illustrating a semiconductor IC according to the seventh embodiment.

Since the construction of the semiconductor IC according to the seventh embodiment is identical to that of the semiconductor IC according to the sixth embodiment, repeated description is not necessary. However, the semiconductor IC le according to the seventh embodiment employs terminals which are not protected from electrostatic destruction, as the address input terminal 3, switching control signal input terminal 7, and test output terminal 8.

As a cause of breakdown of a semiconductor IC, there is a discharge of electrostatic in the environment where the semiconductor IC is placed, or electrostatic that is built in the semiconductor IC itself.

However, in the process of testing the semiconductor IC, since the test is carried out under an environment where a countermeasure against electrostatic destruction is sufficiently made, there is little possibility of breakdown of the semiconductor IC due to terminals being not protected from electrostatic destruction.

In the semiconductor IC le according to this seventh embodiment, terminals to be used for a circuit test, i.e., the address input terminal 3, switching control signal input terminal 7, and test output terminal 8, are not protected from electrostatic destruction.

Next, the operation of the semiconductor IC 1e according to this seventh embodiment will be described.

A circuit test on the semiconductor IC 1e is performed under an environment where a countermeasure against electrostatic destruction is sufficiently made.

Initially, when the semiconductor IC 1e is tested, the switching control signal C1 for selecting the address signals B1˜Bn supplied from the address input terminal 3 is inputted from the switching control signal input terminal 7. On receipt of the switching control signal C1, the address signal selection circuit 4 selects the address signals B1˜Bn according to the switching control signal C1. When the address signals B1˜Bn are inputted to the storage unit 5, the storage unit 5 reads the stored secret data D1˜Dm according to the address signals B1˜Bn. Then, the secret data D1˜Dm read from the storage unit 5 are outputted to the outside through the test output terminal 8.

After the test, a voltage or current is intentionally applied to the semiconductor IC 1e which is judged as a non-defective IC to destroy the address input terminal 3, switching control signal input terminal 7, and test output terminal 8.

As described above, in the semiconductor IC le according to the seventh embodiment, the terminals to be used for the circuit test, i.e., the address input terminal 3, switching control signal input terminal 7, and the test output terminal 8, are not protected from electrostatic destruction. When the semiconductor IC 1e is tested under an environment where a countermeasure against electrostatic destruction is sufficiently made, the secret data D1˜Dm can be read from the storage unit 5 through the test terminals 3, 7, and 8. When the circuit test has ended, a voltage or current is applied to these terminals 3, 7, and 8 to destroy the terminals, whereby the secret data D1˜Dm are prevented from being directly read from the outside after shipment. Therefore, when the IC 1e is tested, the secret data stored in the storage unit 5 can be easily read out to facilitate the test, without degrading confidentiality of the secret data. On the other hand, since the terminals for the test are destroyed after shipment, the secret data are prevented from being leaked to third parties.

While in the first to seventh embodiments the address signals A1˜An to be used when the semiconductor IC is normally used are supplied from the address generation circuit 2 included in the semiconductor IC, these signals may be directly supplied from the outside of the IC, like the address signals B1˜Bn to be used when the IC is tested.

[Embodiment 8]

Hereinafter, an eighth embodiment of the present invention corresponding to claims 8 to 11 will be described with reference to the drawings.

A semiconductor IC according to this eighth embodiment is provided with two storage unit in which secret data of the same contents are stored, and the secret data stored in the respective storage units are compared for every address, thereby checking the correctness of the data stored in the storage units without performing direct control or observation from the outside.

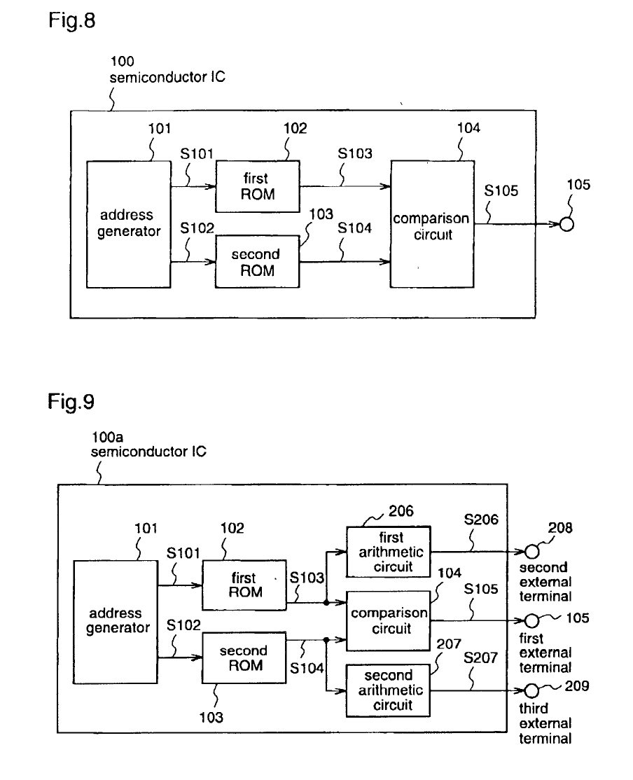

FIG. 8 is a block diagram illustrating a semiconductor IC 100 according to the eighth embodiment.

With reference to FIG. 8, the semiconductor IC 100 is provided with a first ROM (first storage unit) 102 in which secret data that should not be disclosed to third parties are stored; a second ROM (second storage unit) 103 in which data of the same contents as the secret data stored in the first ROM 102 are stored; an address generator 101 for outputting a first address signal S101 to the first ROM 102 or a second address signal S102 to the second ROM 103 to access the ROM; and a comparison circuit (comparator) 104 for comparing first secret data S103 from the first ROM 102 and second secret data S104 from the second ROM 103 to output a match/mismatch signal S105 to a first external terminal 105.

Hereinafter, the operation of the semiconductor IC 100 constructed as mentioned above will be described.

Initially, the first ROM 102 is accessed with the first address signal S101 generated by the address generator 101. Likewise, the second ROM 103 is accessed with the second address signal S102 generated by the address generator 101. At this time, the first and second address signals S101 and S102 outputted from the address generator 101 to the first and second ROMs 102 and 103 are identical.

The first ROM 102 that is accessed with the first address signal S101 outputs the first secret data S103 to the comparison circuit 104 and, simultaneously, the second ROM 103 that is accessed with the second address signal S102 outputs the second secret data S104 to the comparison circuit 104.

Then, the comparison circuit 104 compares the first secret data S103 from the first ROM 102 and the second secret data S104 from the second ROM 103, bit by bit, for every address, and outputs a match/mismatch signal S105. The match/mismatch signal S105 is outputted through the first external terminal 105 to be observed by an external LSI tester (not shown). In the external LSI tester, when all of the observed match/mismatch signals S105 are “match”, the corresponding semiconductor IC 100 is judged as a non-defective IC. On the other hand, when even one of the match/mismatch signals S105 is “mismatch”, the corresponding semiconductor IC is judged as a defective IC.

The above-mentioned process is repeated while successively incrementing the addresses until reaching the final addresses of the first and second ROMs 102 and 103, whereby the whole regions of the first and second ROMs 102 and 103 are tested without direct control or observation from the outside of the semiconductor IC 100.

As described above, the semiconductor IC 100 according to the eighth embodiment is provided with the address generator 101, the first and second storage units 102 and 103 holding the same secret data, and the comparison circuit 104 for judging whether the outputs from the first and second storage units 102 and 103 are identical or not. Therefore, the correctness of the secret data stored in the storage units, which data should not be disclosed to third parties, can be checked in the semiconductor IC 100 without direct control or observation front the outside of the IC 100, whereby the circuit test can be carried out while maintaining the confidentiality of the secret data.

Furthermore, the address generator 101 and the comparison circuit 104 may be implemented by microcomputers. In this case, according to a program, the secret data stored in the first storage unit 102 and the second storage unit 103 are read out, it is checked whether the secret data read from the first storage unit 102 and the secret data read from the second storage unit 103 are identical or not, and the result is outputted to the outside of the semiconductor IC 100. Also in this case, the same effects as mentioned above are achieved.

[Embodiment 9]

Hereinafter, a ninth embodiment of the present invention corresponding to claims 12 to 15 will be described with reference to the drawings.

When the first ROM 102 and the second ROM 103 hold the same contents of data to be compared by the comparison circuit 104 as described for the eighth embodiment, a correct judgement (comparison) result is not always obtained. For example, there is a case where storage of the secret data into the first and second ROMs 102 and 103 is not normally carried out for any reason in the manufacturing process, and the whole regions of the two ROMs have the data of “0” or the data of “1”. In this case, the semiconductor IC is judged as a non-defective IC although it is actually a defective IC. Furthermore, also when the two ROMs have faults in the same address or the same bit, the semiconductor IC cannot correctly be judged as a defective IC. Also in this ninth embodiment, two storage units for holding secret data are provided in a semiconductor IC as in the eighth embodiment, but the secret data stored in the respective storage units are mutually inverted.

FIG. 8 is a block diagram illustrating a semiconductor IC 100 according to the ninth embodiment.

Since the construction of the semiconductor IC 100 according to the ninth embodiment is identical to that of the semiconductor IC according to the eighth embodiment, repeated description is not necessary. In this ninth embodiment, however, the first ROM 102 and the second ROM 103 hold secret data which are mutually inverted.

Hereinafter, the operation of the semiconductor IC 100 will be described.

Initially, the first ROM 102 is accessed with the first address signal S101 generated by the address generator 101. Likewise, the second ROM 103 is accessed with the second address signal S102 generated by the address generator 101. At this time, the first and second address signals S101 and S102 outputted from the address generator 101 to the first and second ROMs 102 and 103 are identical.

The first ROM 102 that is accessed with the first address signal S101 outputs the first secret data S103 to the comparison circuit 104 and, simultaneously, the second ROM 103 that is accessed with the second address signal S102 outputs the second secret data S104 to the comparison circuit 104.

Then, the comparison circuit 104 compares the first secret data S103 from the first ROM 102 and the second secret data S104 from the second ROM 103, bit by bit, for every address, and outputs a match/mismatch signal S105. The match/mismatch signal S105 is outputted through the first external terminal 105 to be observed by an external LSI tester (not shown). In the external LS1 tester, when all of the observed match/mismatch signals S105 are “mismatch”, the corresponding semiconductor IC 100 is judged as a non-defective IC. On the other hand, when even one of the match/mismatch signals S105 is “match”, the corresponding semiconductor IC is judged as a defective IC.

The above-mentioned process is repeated while successively incrementing the addresses until reaching the final addresses of the first and second ROMs 102 and 103, whereby the whole regions of the first and second ROMs 102 and 103 can be tested without direct control or observation from the outside of the semiconductor IC 100.

As described above, in the semiconductor IC according to the ninth embodiment, mutually inverted data are stored in the two storage units 102 and 103, and the match/mismatch signals S105 detected by the external LSI tester are checked, and the semiconductor IC is judged as a non-defective one when all of the match/mismatch signals S105 are “mismatch”. Therefore, even when storage of the data into the first and second ROMs 102 and 103 is not correctly carried out for any reason in the manufacturing process and, thereby, the whole regions of the two ROMs have the data of “0” or the data of “1”, or even when the two storage units have faults in the same address or the same bit, the semiconductor IC can be correctly judged as a defective IC. As a result, more accurate judgement of defective ICs can be carried out, in addition to the effects of the eighth embodiment.

Also in this ninth embodiment, the address generator 101 and the comparison circuit 104 may be implemented by microcomputers In this case, according to a program, the secret data stored in the first storage unit 102 and the second storage unit 103 are read out, it is checked whether the secret data read from the first storage unit 102 and the secret data read from the second storage unit 103 are identical to each other or not, and the result is outputted to the outside of the semiconductor IC 100. Also in this case, the same effects as mentioned above are achieved.

[Embodiment 10]

Hereinafter, a tenth embodiment of the present invention corresponding to claims 16 to 18 will be described with reference to the drawings.

A semiconductor IC according to this tenth embodiment is provided with two storage unit in which secret data of the same contents are stored, and the secret data stored in the respective storage units are compared for every address, and furthermore, the semiconductor IC is provided with an arithmetic circuit for operating the secret data stored in the respective storage units, whereby the correctness of the secret data is checked according to the arithmetic result as well as the judgement result.

FIG. 9 is a block diagram illustrating a semiconductor IC 100a according to the tenth embodiment.

With reference to FIG. 9, the semiconductor IC 100a is provided with a first ROM (first storage unit) 102 in which secret data that should not be disclosed to third parties are stored; a second ROM (second storage unit) 103 in which data of the same contents as the secret data stored in the first ROM 102 are stored; an address generator 101 for outputting a first address signal S101 to the first ROM 102 or a second address signal S102 to the second ROM 103, thereby to access the ROM; a comparison circuit (comparator) 104 for comparing first secret data S103 from the first ROM 102 and second secret data S104 from the second ROM 103 to output a match/mismatch signal S105 to a first external terminal 105; a first arithmetic circuit (first arithmetic unit) 206 for performing a checksum on the first secret data S103 supplied from the first ROM 102, and outputting an arithmetic result S206 to a second external terminal 208; and a second arithmetic circuit (second arithmetic unit) 207 for performing a checksum on the second secret data S104 supplied from the second ROM 103, and outputting an arithmetic result S207 to a third external terminal 209.

Hereinafter, the operation of the semiconductor IC 100a constructed as mentioned above will be described.

Initially, the first ROM 102 is accessed with the first address signal S101 generated by the address generator 101. Likewise, the second ROM 103 is accessed with the second address signal S102 generated by the address generator 101. At this time, the first and second address signals S101 and S102 outputted from the address generator 101 to the first and second ROMs 102 and 103 are identical.

The first ROM 102 that is accessed with the first address signal S101 outputs the first secret data S103 to the comparison circuit 104 and, simultaneously, the second ROM 103 that is accessed with the second address signal S102 outputs the second secret data S104 to the comparison circuit 104.

Then, the comparison circuit 104 compares the first secret data S103 from the first ROM 102 and the second secret data S104 from the second ROM 103, bit by bit, for every address, and outputs a match/mismatch signal S105. The match/mismatch signal S105 is outputted through the first external terminal 105 to be observed by an external LSI tester (not shown). In the external LSI tester, when all of the observed match/mismatch signals S105 are “match”, the corresponding semiconductor IC 100 is judged as a non-defective IC. On the other hand, when even one of the match/mismatch signals S105 is “mismatch”, the corresponding semiconductor IC is judged as a defective IC.

The above-mentioned process is repeated while successively incrementing the addresses until reaching the final addresses of the first and second ROMs 102 and 103, whereby the whole regions of the first and second ROMs 102 and 103 can be tested without direct control or observation from the outside of the semiconductor IC 100a.

Furthermore, in this tenth embodiment, in addition to the judgement by the comparison circuit 104, the secret data S103 and S104 outputted from the first and second ROMs 102 and 103 are inputted to the arithmetic circuits 206 and 207, respectively, and the correctness of the data is judged by performing checksums in the respective arithmetic circuits 206 and 207.

More specifically, the first secret data S103 outputted from the first ROM 102 are inputted to the first arithmetic circuit 206, wherein a checksum is performed on the inputted first secret data S103 to output the arithmetic result S206. Then, the arithmetic result S206 is outputted through the second external terminal 208 to an external LSI tester (not shown), wherein a pass/fail judgement is carried out.

Likewise, the second secret data S104 outputted from the second ROM 103 are inputted to the second arithmetic circuit 207, wherein a checksum is performed on the inputted second secret data S104 to output the arithmetic result S207. Then, the arithmetic result S207 is outputted through the third external terminal 209 to the external LSI tester (not shown), wherein a pass/fail judgement is carried out.

In the external LSI tester (not shown), in addition to the above-described pass/fail judgement by checking the match/mismatch signals S105, a pass/fail judgement according to the arithmetic results S206 and S207 is carried out. To be specific, prepared correct ROM data are regarded as numerical values, and the sum of numerical values (ROM data) is regarded as an expected value of the first and second arithmetic results S206 and S207, and a pass/fail judgement is performed on the data stored in the first and second ROMs 102 and 103.

As described above, the semiconductor IC 100a according to the tenth embodiment is provided with the address generator 101, the first and second storage units 102 and 103 holding the same secret data, the comparison circuit 104 for comparing the outputs from the first and second storage units 102 and 103, and the first and second arithmetic circuits 206 and 207 for performing checksums about the correctness of the secret data stored in the respective storage units 102 and 103. Therefore, the semiconductor IC 100a can be tested while maintaining the confidentiality of the secret data, without directly controlling or observing the storage units 102 and 103 in which the secret data are stored, from the outside of the IC 100a. Further, even when the two storage units 102 and 103 have faults at the same address or the same bit, since the arithmetic results S206 and S207 obtained by the arithmetic circuits 206 and 207 are also outputted, the semiconductor IC can be judged as a defective one when the arithmetic results do not match the arithmetic result according to the prepared correct data, whereby more accurate pass/fail judgement can be performed on the data stored in the storage units.

Further, in this tenth embodiment, when the checksums by the arithmetic circuits 206 and 207 result in that either of the first and second storage units 102 and 103 is correct, the correct storage unit may be selected. That is, even when the first ROM 102 is a defective, the pass/fail judgement can be correctly carried out as long as the second ROM 103 is a non-defective, whereby the yield in the test is increased.

While in this tenth embodiment the two ROMs 102 and 103 have the same contents, these ROMs may have mutually inverted data. In this case, as checksums to be performed by the respective arithmetic circuits 206 and 207, any arithmetic method by which the correctness of the stored data can be checked, for example, counting the sum of “0” for one of the two ROMs while counting the sum of “1” for the other ROM, may be employed, with the same effects as mentioned above.

Furthermore, also in this tenth embodiment, the address generator 101, the comparison circuit 104, and the arithmetic circuits 206 and 207 may be implemented by microcomputers. In this case, according to programs of the microcomputers, the secret data stored in the first storage unit 102 and the second storage unit 103 are read out, it is checked whether the secret data read from the first storage unit 102 and the secret data read from the second storage unit 103 are identical or not, and the result is outputted to the outside of the semiconductor IC 100a. Furthermore, the arithmetic operations for checking the correctness of the data stored in the first and second storage units 102 and 103 are carried out, and the results are outputted to the outside of the semiconductor IC 100a. Also in this case, the same effects as mentioned above are achieved.

While in this tenth embodiment the arithmetic circuits 206 and 207 perform checksums, the arithmetic operations are not restricted thereto. For example, the arithmetic circuits 206 and 207 may perform CRC check.

[Embodiment 11]

Hereinafter, an eleventh embodiment of the present invention corresponding to claim 19 will be described with reference to the drawings.

A semiconductor IC according to this eleventh embodiment is provided with a self-judgement circuit for judging the correctness of secret data according to an arithmetic result, and a selection unit for selecting one of plural storage units where the secret data are correctly stored, according to the judgement result, whereby the correctness of the secret data stored in the storage units is checked without direct control or observation from the outside.

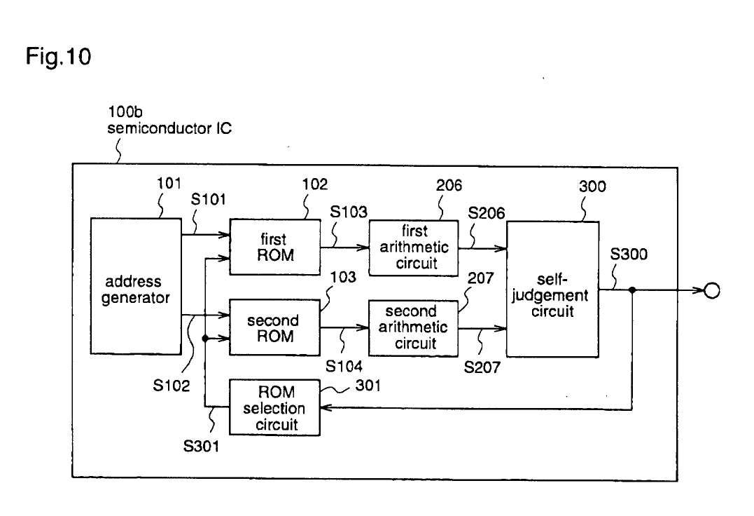

FIG. 10 is a block diagram illustrating a semiconductor IC 100b according to the eleventh embodiment.

With reference to FIG. 10, the semiconductor IC 100b is provided with an address generator 101; a first ROM 102 and a second ROM 103 holding the same secret data; a first arithmetic circuit 206 and a second arithmetic circuit 207 for checking the correctness of the secret data stored in the respective ROMs; a self-judgement circuit (self-judgement unit) 300 to which the results of the two arithmetic circuits are inputted; and a ROM selection circuit (selection unit) 301 for outputting a ROM selection signal S301 that selects a ROM to be used, according to the result of the self-judgement circuit 300.

The judgement rule of the self-judgement circuit 300 is as follows. When the arithmetic results of both of the first arithmetic circuit 206 and the second arithmetic circuit 207 are correct, either one of the first and second ROMs 102 and 103 can be used. When the result of either one of the two arithmetic circuits is correct, the ROM outputting the correct result is selected. When the arithmetic results of both of the two arithmetic circuits are not correct, the corresponding semiconductor IC is failed as a defective IC.

Hereinafter, the operation of the semiconductor IC 100b constructed as described above will be described.

Initially, the first ROM 102 is accessed with a first address signal S101 generated by the address generator 101. Then, first secret data S103 is outputted from the first ROM 102 according to the first address signal S101, and the first secret data S103 is inputted to the first arithmetic circuit 206. In the first arithmetic circuit 206, a predetermined arithmetic operation is performed on the first secret data S103 and, thereafter, an arithmetic result S206 is inputted to the self-judgement circuit 300.

Likewise, the second ROM 103 is accessed with a second address signal S102 that is generated by the address generator 101. Then, second secret data S104 from the second ROM 103 is inputted to the second arithmetic circuit 207, and a predetermined arithmetic operation is performed on the second secret data S104 and, thereafter, an arithmetic result S207 is inputted to the self-judgement circuit 300.

The above-mentioned process is repeated while successively incrementing the addresses until reaching the final addresses of the respective ROMs, whereby the whole regions of the first and second ROMs 102 and 103 can be tested without direct control or observation from the outside of the semiconductor IC 100b.

In the self-judgement circuit 300, the arithmetic results S206 and S207 of the two ROMs are judged by a checksum or the like. When both of the arithmetic results are correct, either one of the two ROMs may be used. When one of the arithmetic results is correct, the ROM outputting the correct result is selected. When both of the arithmetic results are not correct, the semiconductor IC is judged as a defective IC, and a judgement result S300 is outputted to the ROM selection circuit 301.

The ROM selection circuit 301 outputs a ROM selection signal S301 to the first and second ROMs, according to the judgement result S300 from the self-judgement circuit 300.

That is, even when the first ROM 102 is a defective, the semiconductor IC is judged as a non-defective IC if the second ROM 103′ is a non-defective, whereby the yield in the test is improved.

As described above, the semiconductor IC 100b according to the eleventh embodiment is provided with the address generator 101, the first and second storage units 102 and 103 holding the same secret data, the first and second arithmetic circuits 206 and 207 for operating the outputs from the respective storage units 102 and 103, the self-judgement circuit 300 for judging the arithmetic results of the arithmetic circuits 206 and 207, and the ROM selection circuit 301 for selecting a storage unit to be used, according to the judgement result from the self-judgement circuit 300. Therefore, the correctness of the secret data stored in the storage units, which data should not be disclosed to third parties, can be checked without direct control or observation from the outside of the semiconductor IC 100b, while maintaining the confidentiality of the secret data. Furthermore, the semiconductor IC 100b is judged as a non-defective IC as long as either one of the arithmetic results from the arithmetic circuits 206 and 207 is correct, whereby the yield in the test can be improved.

[Embodiment 2]

Hereinafter, a twelfth embodiment of the present invention corresponding to claim 20 will be described with reference to the drawings.

In this twelfth embodiment, on a semiconductor IC having a storage unit in which secret data is stored, a DSP including a ROM in which data of the same contents as the data stored in the storage unit is stored is provided, whereby a pass/fail judgement is performed on the secret data stored in the storage unit, without direct control or observation from the outside.

FIG. 11 is a block diagram illustrating a semiconductor IC 100c according to the twelfth embodiment.

With reference to FIG. 11, the semiconductor IC 100c is provided with an internal ROM (storage unit) 401 in which secret data that should not be disclosed to third parties is stored; a DSP (Digital Signal Processor) containing a ROM (not shown) in which the same data as the data stored in the internal ROM 401 is stored; and an external terminal 403.

Hereinafter, the operation of the semiconductor IC 100c constructed as described above will be described.

When the semiconductor IC 100c is tested, the DSP 402 accesses the internal ROM 401 with an address signal S400, and captures secret data S401 stored in the internal ROM 401. Then, the DSP 402, holding the same data as the secret data S401 stored in the internal ROM 401, compares the data stored in itself with the secret data S401 stored in the ROM 401, thereby performing a pass/fail judgement, and outputs a judgement result S402 to the external terminal 403.

As described above, the semiconductor IC 100c according to the twelfth embodiment is provided with the internal ROM 401, and the DSP 402 containing the same data as the secret data stored in the ROM 401. Therefore, the circuit test can be carried out without directly controlling or observing the internal ROM 401 in which the secret data that should not be disclosed to third parties is stored, from the outside of the semiconductor IC 100c, while maintaining the confidentiality of the secret data.

[Embodiment 13]

Hereinafter, a thirteenth embodiment of the present invention corresponding to claim 21 will be described with reference to the drawings.

While in the twelfth embodiment the ROM in the DSP holds the same data as the secret data, in this thirteenth embodiment the DSP holds, by software, the same data as the secret data.

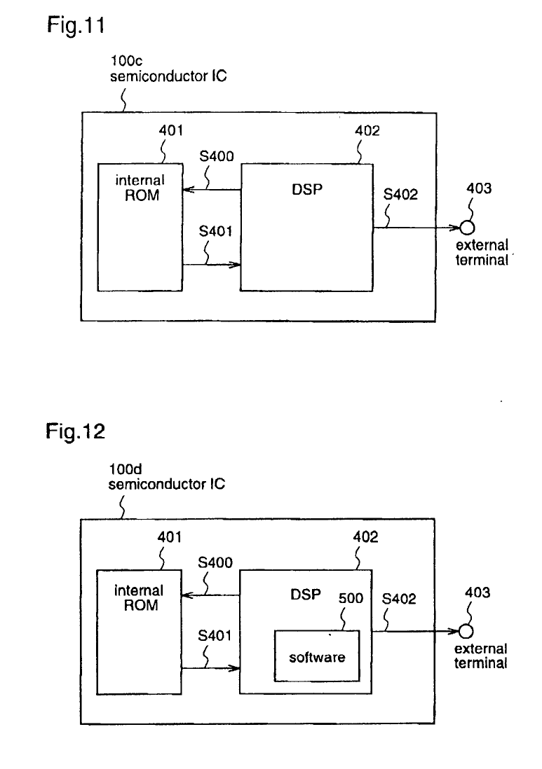

FIG. 12 is a block diagram illustrating a semiconductor IC 100d according to the thirteenth embodiment.

The semiconductor IC 100d according to the thirteenth embodiment is different from the semiconductor IC 100c according to the twelfth embodiment only in that the same data as the secret data stored in the internal ROM 401 is stored by software 500 in the DSP 402. Since other constituents of the semiconductor IC 100d are identical to those of the semiconductor IC 100c, repeated description is not necessary.

Hereinafter, the operation of the semiconductor IC 100d constructed as described above will be described.

When the semiconductor IC 100d is tested, the DSP 402 accesses the internal ROM 401 with an address signal S400, and captures secret data S401 from the internal ROM 401. The DSP 402 holds the same data as the secret data S401 stored in the internal ROM 401, in a data region of the software 500, and compares the data stored in the software 500 with the secret data S401 stored in the ROM 401 to perform a pass/fail judgement, and outputs a judgement result S402 to the external terminal 403.

As described above, in the semiconductor IC 100d according to the thirteenth embodiment, the same data as the secret data stored in the internal ROM 401 are stored in the software 500 of the DSP 402. Therefore, the circuit test can be speedily carried out without directly controlling or observing the internal ROM 401 in which the secret data that should not be disclosed to third parties is stored, from the outside of the semiconductor IC 100d, while maintaining the confidentiality of the secret data.

While in the twelfth or thirteenth embodiment the semiconductor IC 100c or 100d is provided with the DSP 402 which holds the same data as the secret data stored in the storage unit, the semiconductor IC may be provided with an ordinary microcomputer instead of the DSP 402.

[Embodiment 14]

Hereinafter, a fourteenth embodiment of the present invention corresponding to claim 22 will be described with reference to the drawings.

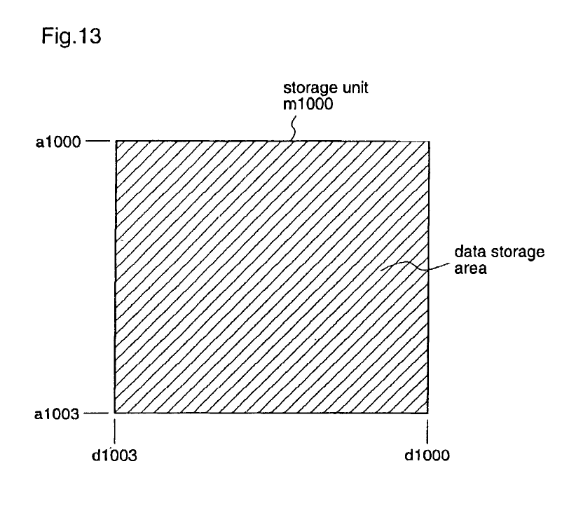

As shown in FIG. 13, conventionally, a memory map of a storage unit m1000 uses, as a data storage area, the whole region indicated by memory addresses a1000˜a1003 and data bits d1000˜d1003. Assuming that the storage unit m1000 is a common memory such as a mask ROM (Read Only Memory) which discriminates between “0” and “1” using contact masks, when a third party opens the IC chip and tries to analyze the contents of secret data stored in the storage unit m1000 of the above-mentioned data arrangement, the third party can easily analyze the contents because the stored data can easily be discriminated between “0” and “1” by detecting the presence/absence of the contact masks. In this fourteenth embodiment, to avoid this problem, a second data storage area for holding ineffective random data is provided in the storage unit m1000, besides the first data storage area for holding effective data which are secret data to be protected.

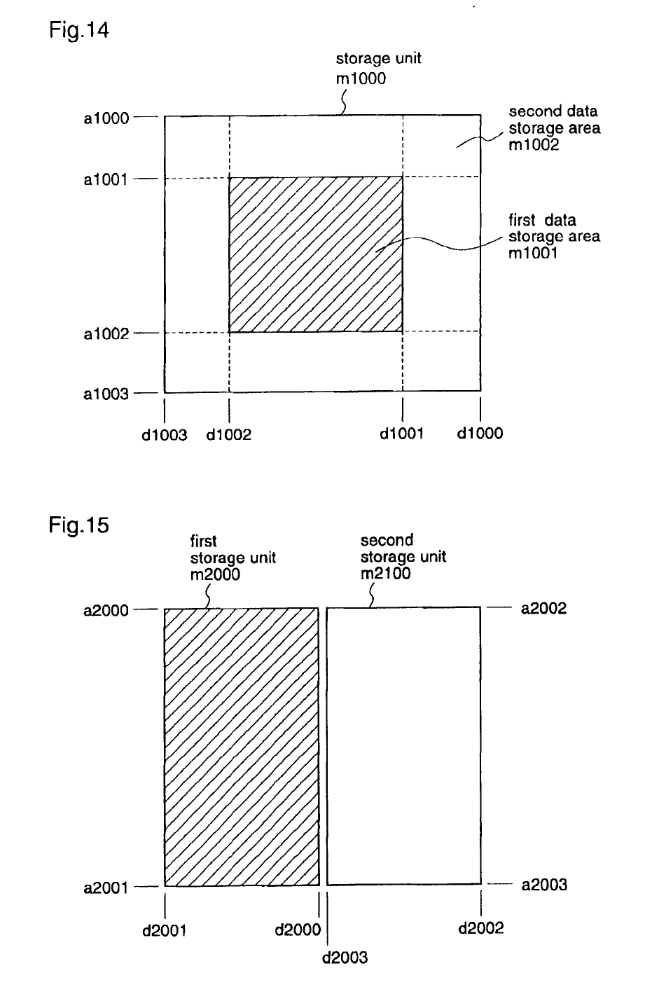

FIG. 14 is a conceptual diagram of a memory map illustrating a data arrangement in a storage unit of a semiconductor storage apparatus according to the fourteenth embodiment.

With reference to FIG. 14, m1000 denotes a storage unit for holding secret data, a1000˜a1003 denote memory addresses, respectively, and d1000˜d1003 denote data bits. Further, a data storage area is indicated by the addresses a1000˜a1003 and the data bits d1000˜d1003. In this area, effective data such as secret data to be protected are arranged in a first data storage area m1001 surrounded by the addresses a1001˜a1002 and the data bits d1001˜d1002 (hatched area), and ineffective random data are arranged in a second data storage area m1002 that is a memory area other than the first data storage area m1001.

As means for holding these data, a common storage unit such as a mask ROM (Read Only Memory) which discriminates between “0” and “1” using contact masks, is employed.

As described above, when the storage unit m1000 is a common storage means such as a mask ROM which discriminates between “0” and “1” using contact masks, if a third party opens the IC chip to analyze the contents of the secret data, the third party can easily analyze the data by detecting presence/absence of the contact masks.

However, even when the third party can know a sequence of data stored in the address a1001, the third party can never know which part of this data sequence is effective. In order to analyze the secret data by detecting the effective part of the data sequence, it is necessary to analyze a circuit which is connected in a stage subsequent to the storage unit m1000 and utilizes the secret data. However, since the subsequent stage is usually constituted by a large-scale gate circuit, it is significantly difficult to analyze this stage as compared with analysis of the storage unit m1000.

As described above, the semiconductor storage apparatus according to the fourteenth embodiment employs, as a storage unit for holding secret data, the storage unit m1000 having a capacity larger than the amount of data to be stored, and the first data storage area m1001 for holding effective data such as secret data to be protected is placed in the center of the data storage area of the storage unit m1000, and the second data storage area m1002 for holding ineffective random data is placed in part other than the first data storage area m1001. Therefore, even when a third party opens the storage unit m1000 and analyzes the information of “0” and “1” of the stored secret data, it is very difficult for the third party to extract the effective part of the secret data and utilize it, whereby the confidentiality of the data stored in the semiconductor storage apparatus is significantly improved.

While in-this fourteenth embodiment the ineffective data are arranged surrounding all sides of the effective data area, the same effect as mentioned above can be achieved when the ineffective data are adjacent to at least one side of the effective data area.

[Embodiment 15]

Hereinafter, a fifteenth embodiment of the present invention corresponding to claim 23 will be described with reference to the drawings.

A semiconductor storage apparatus according to this fifteenth embodiment is provided with a first storage unit and a second storage unit which have the same characteristics in configuration, and effective data such as secret data are stored in the first storage unit while ineffective data are stored in the second storage unit.

FIG. 15 is a conceptual diagram of a memory map illustrating an arrangement of data in the storage units of the semiconductor storage apparatus according to the fifteenth embodiment.

With reference to FIG. 15, m2000 and m2001 denote first and second storage units. The first storage unit m2000 holds effective data such as secret data, and the second storage unit m2002 holds ineffective data. Further, a2000˜a2003 denote memory addresses, respectively, and d2000˜d2003 denote data bits.

In FIG. 15, the first storage unit m2000 corresponds to a hatched space indicated by the addresses a2000˜a2001 and the data bits d2000˜d2001, wherein effective data such as secret data to be protected are arranged. Further, ineffective random data are arranged in the second storage unit m2001 (a space indicated by the addresses a2002˜a2003 and the data bits d2002˜d2003) having the same characteristics, such as the capacity, data arrangement pattern, and the like, as the first storage unit m2000 holding the secret data.

As means for holding these data, a common storage unit such as a mask ROM (Read Only Memory) which discriminates between “0” and “1” using contact masks, is employed.

As described above, when each of the storage units m2000 and m2001 is a common storage means such as a mask ROM which discriminates between “0” and “1” using contact masks, if a third party opens the IC chip to analyze the contents of the stored secret data, the third party can easily analyze the data by detecting presence/absence of the contact masks.

However, even when the third party can know a sequence of data stored in the address a2001, the third party can never know whether the stored data are effective or not unless analyzing a circuit which is connected in a stage subsequent to the storage units m2000 and m2001 and utilizes the secret data. However, the subsequent stage is usually constituted by a large-scale gate circuit, and it is significantly difficult to analyze this stage as compared with analysis of the storage units m2000 and m2001.

As described above, the semiconductor storage apparatus according to the fifteenth embodiment employs, as storage units, the first storage unit m2000 holding the effective data such as secret data, and the second storage unit m2002 holding ineffective data and having the same characteristics in configuration as the first storage unit m2000. Therefore, it is difficult to find which storage unit holds the effective data such as secret data. Even when a third party opens all of the storage units and analyzes the information of “0” and “1” of the stored data, it is very difficult for the third party to judge which data is effective and utilize the data, whereby the confidentiality of the data stored in the semiconductor storage apparatus is significantly improved.

While in this fifteenth embodiment the semiconductor storage apparatus has two storage units, the larger the number of storage units is, the more the difficulty increases for the third party who tries to analyze the secret data, whereby the confidentiality is further improved.

[Embodiment 16]

Hereinafter, a sixteenth embodiment of the present invention corresponding to claims 24 and 26 will be described with reference to the drawings.

A semiconductor storage apparatus according to this sixteenth embodiment is provided with first to ninth storage units which have the same characteristics in configuration, and effective data such as secret data are stored in the first storage unit while ineffective data are stored in the second to ninth storage units which are arranged surrounding the first storage unit.

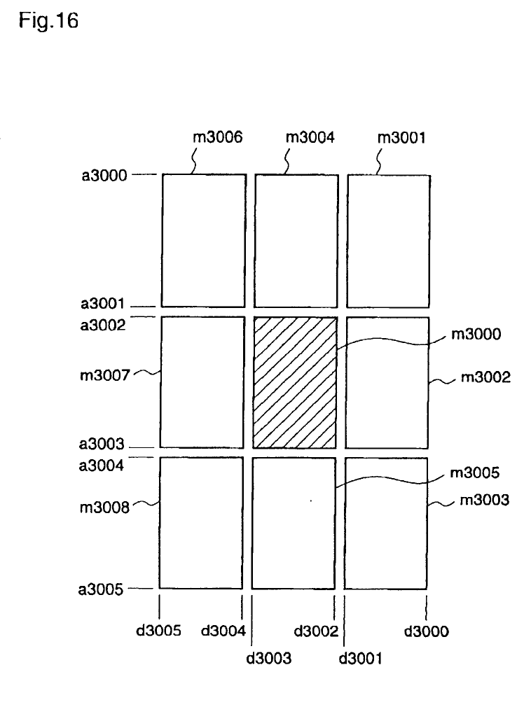

FIG. 16 is a conceptual diagram of a memory map illustrating an arrangement of data in the semiconductor storage apparatus according to the sixteenth embodiment.

With reference to FIG. 16, m3000 denotes a first storage unit holding effective data, and m3001˜m3008 denote second to ninth storage units holding ineffective data. Further, a3000˜a3005 denote memory addresses, respectively, and d3000˜d3005 denote data bits.

In FIG. 16, the first storage unit m3000 corresponds to a hatched space indicated by the addresses a3002˜a3003 and the data bits d3002˜d3003, wherein effective data such as secret data to be protected are arranged.

Further, ineffective random data are stored in the eight storage units having the same characteristics (e.g., the capacity, data arrangement pattern, and the like) as the first storage unit m3000 holding the secret data, namely, the second storage unit m3001 (a space indicated by addresses a3000˜a3001 and data bits d3000˜d3001), the third storage unit m3002 (a space indicated by addresses a3002˜a3003 and data bits d3000˜d3001), the fourth storage unit m3003 (a space indicated by addresses a3004˜a3005 and data bits d3000˜d3001), the fifth storage unit m3004 (a space indicated by addresses a3000˜a3001 and data bits d3002˜d3003), the sixth storage unit m3005 (a space indicated by addresses a3004˜a3005 and data bits d3002˜d3003), the seventh storage unit m3006 (a space indicated by addresses a3000˜a3001 and data bits d3004˜d3005), the eighth storage unit m3007 (a space indicated by addresses a3002˜a3003 and data bits d3004˜d3005), and the ninth storage unit m3008 (a space indicated by addresses a3004˜a3005 and data bits d3004˜d3005).

As means for holding these data, a common storage unit such as a mask ROM (Read Only Memory) which discriminates between “0” and “1” using contact masks, is employed.

The first to ninth storage units are physically arrange such that the first storage unit m3000 holding effective data such as secret data is surrounded by the second to ninth storage units m3001˜m3008 holding ineffective data.

The second to ninth storage units m3001˜m3008 are readable from the outside by a test circuit, and the first storage unit m3000 placed in the center and holding effective data is not readable by the test circuit.

As described above, when each of the nine storage units m3000˜m3008 is a common storage means such as a mask ROM which discriminates between “0” and “1” using contact masks, if a third party opens the IC chip and tries to analyze the contents of the stored secret data, the third party can easily analyze the data by detecting presence/absence of the contact masks.

However, the third party can never know which data sequence is effective among the data stored in the nine storage units m3000˜m3008 unless analyzing a circuit that is connected in a stage subsequent to the storage units and utilizes the secret data. However, since the subsequent stage is usually constituted by a large-scale gate circuit, it is significantly difficult to analyze this stage as compared with analysis of the storage units m3000˜m3008.

Furthermore, it is well known that a fault of a semiconductor IC is caused by attachment of dust or the like during processing, and it is also known that, when a part of the semiconductor IC has a fault due to dust, the fault extends to its peripheral part.

Accordingly, when the peripheral part has even a single fault, the possibility of the central part being non-defective is significantly reduced, and therefore, the central part may be judged as being defective when the peripheral part is defective.

In this sixteenth embodiment, as shown in FIG. 16, the first storage unit m3000 holding effective data such as secret data is surrounded by the second to ninth storage units m3001˜m3008 holding ineffective data, and the second to ninth storage units m3001˜m3008 are readable from the outside.

Since the first storage unit m3000 cannot be read from the outside, it is difficult to test the first storage unit m3000 from the outside. However, since it is easy to test the second to ninth storage units m3001˜m3008 from the outside, these eighth storage units m3001˜m3008 are tested, and the first storage unit m3000 placed in the center can be judged as a defective when even one of the eight storage units is judged as a defective. Accordingly, by employing the arrangement of the storage units according to the sixteenth embodiment, even a person who conducts the test cannot know the contents of the secret data.

As described above, the semiconductor storage apparatus according to the sixteenth embodiment is provided with the first storage unit m3000 for holding effective data such as secret data, and the second to ninth storage units m3001˜m3008 having the same characteristics in configuration as the first storage unit m3000. Therefore, it is difficult to know which storage unit holds the effective data such as secret data. Further, even when a third party opens all of the storage units and analyzes the information of “0”, and “1” of the stored data, it is very difficult for the third party to judge which data is effective and utilize the data, whereby the confidentiality of the data stored in the semiconductor storage apparatus is greatly improved

Furthermore, since, among the nine storage units m3000˜m3008, the eight storage units m3001˜m3008 for holding ineffective data are readable from the outside, it is easy to test these storage units m3001˜m3008 from the outside. Accordingly, when at least one of the results of tests performed on the eight storage units m3001˜m3008 is “defective”, the central storage unit holding effective data is also judged as “defective”, whereby the contents of the secret data stored in the first storage unit m3000 can be concealed from even a person who conducts the test. As the result, the data confidentiality of the semiconductor IC can be further improved.

[Embodiment 17]

Hereinafter, a seventeenth embodiment of the present invention corresponding to claims 25 and 26 will be described with reference to the drawings.

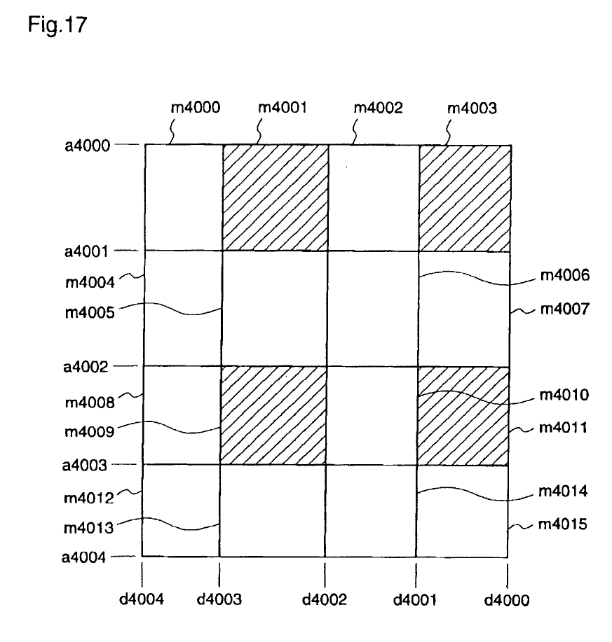

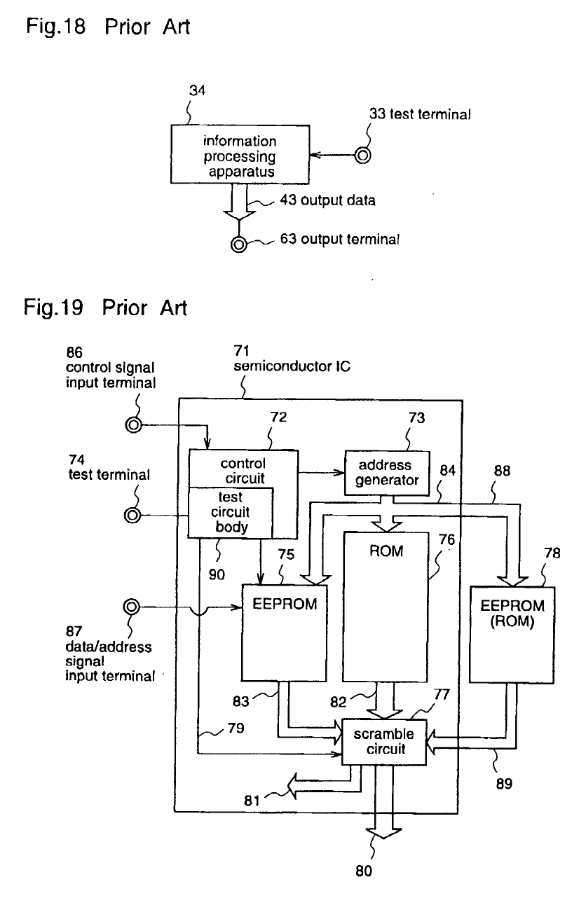

FIG. 17 is a conceptual diagram of a memory map illustrating an arrangement of data in a storage unit of a semiconductor storage apparatus according to the seventeenth embodiment.

In FIG. 17, m4000˜m4015 denote first to sixteenth data storage areas of a single storage unit, a4000˜a4004 denote memory addresses, and d4000˜d4004 denote data bits. In this seventeenth embodiment, hatched areas are effective data storage areas for holding effective data such as secret data. To be specific, effective data such as secret data are stored in four areas as follows: the second data storage area m4001 (a space area indicated by addresses a4002˜a4003 and data bits d4000˜d4001), the fourth data storage area m4003 (a space indicated by addresses a4000˜a4001 and data bits d4000˜d4001), the tenth data storage area m4009 (a space indicated by addresses a4002˜a4003 and data bits d4002˜d4003), and the twelfth data storage area m4011 (a space indicated by addresses a4000˜a4001 and data bits d4002˜d4003). Ineffective data are stored in the data storage areas other than mentioned above.

As means for holding these data, a common storage unit such as a mask ROM (Read Only Memory) which discriminates between “0” and “1” using contact masks, is employed.

Although the effective data storage spaces are unreadable from the outside of the semiconductor IC, the ineffective data storage spaces other than the effective data storage spaces are readable from the outside by a test circuit.

When a third party opens the chip to analyze the contents of the data which are arranged in the storage unit as described above, the third party can easily check whether each of the stored data is “0” or “1”, by detecting presence/absence of the contact masks.

However, the third party can never know which data sequence is effective among the data that have been checked as “0” or “1”, unless analyzing a circuit that is connected in a stage subsequent to the storage unit and utilizes the obtained data. However, since the subsequent stage is usually constituted by a large-scale gate circuit, it is significantly difficult to analyze this stage as compared with analysis of the storage unit.

As described above, the semiconductor storage apparatus according to the seventeenth embodiment is provided with the storage unit comprising the first to sixteenth data storage areas, and effective data such as secret data are stored in the second, fourth, tenth, and twelfth data storage areas m4001, m4003, m4009, and m4011. Therefore, even when the information of “0” and “1” of the effective data stored in the second, fourth, tenth, and twelfth data storage areas is analyzed by a third party, it is very difficult for the third party to extract the effective part of the data and utilize it, whereby the confidentiality of the data stored in the semiconductor storage apparatus is significantly improved.

Furthermore, since, in the storage unit, the effective data storage areas are adjacent to the ineffective data storage areas as in the above-mentioned sixteenth embodiment, when there is a defect in the ineffective data storage area, the possibility of the effective data storage area having a defect is significantly increased. Accordingly, by only performing a defective/non-defective test on the ineffective data storage areas without directly testing the effective data storage areas, the result of this test can be used as a result of a defective/non-defective test on the effective data storage areas. That is, in the construction according to the seventeenth embodiment, since the ineffective data storage areas are designed so as to be directly readable from the outside of the semiconductor IC, it is very easy to test the ineffective data storage areas, and therefore, whether the effective data storage areas are defective or not is also easily known on the basis of the result of the test on the ineffective data storage areas. Furthermore, in this test method, even a person who conducts the test cannot know the contents of the effective data, the data confidentiality of the semiconductor IC is further improved.

In this seventeenth embodiment, the arrangement of the data storage areas in the storage unit is described taking an example in which the addresses and the data bits are respectively divided into four parts. However, the addresses and the data bits may be independently divided into an arbitrary number of parts except for “1”, with the same effects as mentioned above.

When dividing the inside of the storage unit into plural areas, the amount of division is may be set to an arbitrary amount that is larger than the minimum units of addresses and data bits, independently for each division.

Furthermore, while in the fifteenth to seventeenth embodiments one data storage area or plural data storage areas is/are included in one data storage area, one data storage area may be arranged over plural storage units.

[Embodiment 18]

Hereinafter, an eighteenth embodiment of the present invention corresponding to claim 27 will be described with reference to the drawings.

In the fourteenth to seventeenth embodiments, a storage means such as a mask ROM is employed as a data storage system. However, the mask ROM system has a disadvantage that, when a third party opens the package of the semiconductor IC containing the mask ROM to analyze the stored data, the third party can easily discriminates the data between “0” and “1”.

In order to offset this disadvantage, an EP-ROM system is employed as the storage unit in this eighteenth embodiment.

An EP-ROM holds data by holding electrical charge, and the held charge is erasable by ultraviolet light. In an EP-ROM system, an EP-ROM chip is sealed in a package that is opaque to ultraviolet light. In an EP-ROM system semiconductor storage apparatus, when a third party who desires to know the stored data opens the package of the semiconductor IC containing the storage unit to analyze the data, the third party must expose the data storage system by removing a protection film or the like at the top of data storage system. Therefore, during the analysis work, the stored data are erased by ultraviolet light included in light from lighting equipment or the like, and the analysis of the data contents ends in failure.

As described above, the semiconductor storage apparatus according to the eighteenth embodiment employs an EP-ROM system storage unit as a storage means for holding secret data, and the EP-ROM storage unit has both of a storage area for effective data such as secret data and a storage area for ineffective random data, or it holds effective data and ineffective data which are alternately arranged, like any of the above-mentioned embodiments, thereby to make it difficult to judge which part of data is effective. Further, when a third party tries to open the EP-ROM system storage unit, the stored data itself is erased, whereby the data confidentiality of the semiconductor IC is significantly improved. Moreover, the above-mentioned construction makes it significantly difficult to discriminate between effective data and ineffective data by another method to utilize the data.

What is claimed is:

1. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and
an arithmetic unit for performing an arithmetic operation according to a predetermined secret rule, on the secret data which are read from the storage unit according to the second address signal, and outputting a result of the arithmetic operation to the outside.

2. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and
an arithmetic unit for arithmetically operating plural data which are supplied from the outside, and determining, according to combinations of the data, whether the secret data which are read from the storage unit according to the second address signal are to be outputted to the outside or not.

3. A semiconductor IC including:
a storage unit for holding secret data;
an arithmetic unit for arithmetically operating plural data which are supplied from the outside, and outputting, according to combinations of the data, a selection signal for selecting an address signal to be given to the storage unit; and
an address signal selection unit for selecting either a first address signal to be given to the storage unit when the semiconductor IC is normally used, or a second address signal to be given to the storage unit when the semiconductor IC is tested, according to the selection signal supplied from the arithmetic unit, and outputting the selected signal to the storage unit.

4. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and
a timing detection unit for outputting the selection signal so as to enable the second address signal only during a predetermined period of time, thereby controlling the address signal selection unit.

5. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit; and
plural fuses which are able to disconnect conducting paths by applying a predetermined voltage or current to the fuses;
wherein said fuses are placed in a path through which the second address signal supplied from the outside is inputted to the address signal selection unit, and in a path through which the secret data read from the storage unit are outputted to the outside.

6. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit;
an address input terminal to which the second address signal is supplied from the outside; and
an output terminal for outputting the secret data which are read from the storage unit according to the second address signal, to the outside;
wherein, among plural terminals on a wafer, said address input terminal and said output terminal are not connected to external terminals of a package of the semiconductor IC.

7. A semiconductor IC including:
a storage unit for holding secret data;
an address signal selection unit for selecting either a first address signal to be given to the storage unit when the semiconductor IC is normally used, or a second address signal to be given to the storage unit when the semiconductor IC is tested, according to a selection signal supplied from the outside, and outputting the selected signal to the storage unit;
an address input terminal to which the second address signal is supplied from the outside; and
an output terminal for outputting the secret data which are read from the storage unit according to the second address signal, to the outside of the semiconductor IC;
wherein said address input terminal and said output terminal are not protected against electrostatic destruction.

8. A semiconductor IC including:
first and second storage units each holding secret data, and being unreadable from the outside; and
a comparison unit for comparing the data stored in the first storage unit and the data stored in the second storage unit to judge whether these data are identical or not, and outputting a result of the comparison to the outside.

9. The semiconductor IC defined in claim 8, wherein the first and second storage units hold the same secret data.

10. A method for testing the semiconductor IC defined in claim 8 or 9, comprising:
a reading step of reading the data stored in the first and second storage units;
a comparison step of comparing the data read from the first storage unit and the data read from the second storage unit to judge whether these data are identical or not; and
an output step of outputting a result of the comparison in the comparison step to the outside.

11. A test program for allowing a computer to execute a test on the semiconductor IC defined in claim 8 or 9, comprising:
a reading step of reading the data stored in the first and second storage units;
a comparison step of comparing the data read from the first storage unit and the data read from the second storage unit to judge whether these data are identical or not; and
an output step of outputting a result of the comparison in the comparison step to the outside.

12. A semiconductor IC including:
first and second storage units each holding secret data, and being unreadable from the outside; and
a comparison unit for comparing the data stored in the first storage unit and the data stored in the second storage unit to judge whether these data are different from each other or not, and outputting a result of the comparison to the outside.

13. The semiconductor IC defined in claim 12, wherein the first and second storage units hold mutually-inverted secret data.

14. A method for testing the semiconductor IC defined in claim 12 or 13, comprising:
a reading step of reading the data stored in the first and second storage units;
a comparison step of comparing the data read from the first storage unit and the data read from the second storage unit to judge whether these data are different from each other or not; and
an output step of outputting a result of the comparison in the comparison step to the outside.

15. A test program for allowing a computer to execute a test on the semiconductor IC defined in claim 12 or 13, comprising:
a reading step of reading the data stored in the first and second storage units;
a comparison step of comparing the data read from the first storage unit and the data read from the second storage unit to judge whether these data are different from each other or not; and
an output step of outputting a result of the comparison in the comparison step to the outside.

16. The semiconductor IC defined in any of claims 8, 9, 12, and 13 further including;
first and second arithmetic units for performing arithmetic operations to check the correctness of the secret data stored in the first and second storage units, respectively, and outputting results of the arithmetic operations to the outside.

17. A method for testing the semiconductor IC defined in claim 10 or 14, comprising:
an arithmetic step of performing arithmetic operations to check the correctness of the secret data stored in the first and second storage units; and
an output step of outputting a result obtained in the arithmetic step to the outside.

18. The semiconductor IC test program defined in claim 11 or 15, further including:
an arithmetic step of performing arithmetic operations to check the correctness of the secret data stored in the first and second storage units; and
an output step of outputting a result obtained in the arithmetic step to the outside.

19. A semiconductor IC including:
first and second storage units each holding secret data;
first and second arithmetic units for performing arithmetic operations to check the correctness of the secret data stored in the first and second storage units, respectively;
a self-judgement unit for making a judgement to select either the first storage unit or the second storage unit, on the basis of the results of the arithmetic operations performed by the first and second arithmetic units; and
a selection unit for selecting a storage unit to be used from between the first and second storage units, on the basis of the result of the judgement of the self-judgement unit.

20. A semiconductor IC including:
a storage unit for holding secret data; and
a data processor for holding, as internal data, the same data as the secret data stored in the storage unit;
wherein the data processor compares the internal data with the secret data stored in the storage unit, and outputs a result of the comparison to the outside.

21. The semiconductor IC defined in claim 20, wherein the data processor holds the same data as the secret data stored in the storage unit, in a part of software that is contained in the data processor.

22. A semiconductor storage apparatus including:
a storage unit having a capacity larger than an amount of effective data;
wherein the effective data are placed in a first data storage area that is a part of a data storage area of the storage unit, and ineffective data are placed in a second data storage area other than the first data storage area.

23. A semiconductor storage apparatus including:
plural storage units for holding data;
wherein effective data are stored in at least one of the plural storage units, and ineffective data are stored in the remaining storage units other than the storage unit which hold the effective data.

24. The semiconductor storage apparatus defined in claim 23, wherein the plural storage units are arranged such that the storage unit holding the effective data is surrounded by the storage units holding the ineffective data.

25. The semiconductor storage apparatus defined in claim 22, wherein the effective data and the ineffective data are alternately arranged in the data storage area of the storage unit.

26. The semiconductor storage apparatus defined in any of claims 22 to 25, wherein the part of the storage unit holding the ineffective data is readable from the outside, and the part of the storage unit holding the effective data is unreadable from the outside.

27. The semiconductor storage apparatus defined in any of claims 22 to 26, wherein
the storage unit consists of at least one EP-ROM; and
the EP-ROM is sealed in a package that is opaque to ultraviolet light.
